(19) United States
(12) Patent Application Publication
(10) Pub. No.: US 2018/0317134 A1
(43) Pub. Date: Nov. 1, 2018

(54) NSSMF NSMF INTERACTION CONNECTING VIRTUAL 5G NETWORKS AND SUBNETS

(71) Applicants: Philippe LEROUX, Ottawa (CA); Nimal Gamini SENARATH, Ottawa (CA); Chengchao LIANG, Ottawa (CA)

(72) Inventors: Philippe LEROUX, Ottawa (CA); Nimal Gamini SENARATH, Ottawa (CA); Chengchao LIANG, Ottawa (CA)

(73) Assignee: Huawei Technologies Co., Ltd., Shenzhen (CN)

(21) Appl. No.: 15/959,451

(22) Filed: Apr. 23, 2018

Related U.S. Application Data
(60) Provisional application No. 62/491,852, filed on Apr. 28, 2017.
(60) Provisional application No. 62/502,481, filed on May 5, 2017.

(51) Int. Cl. H04W 28/26; H04L 12/24; H04W 8/22

(52) U.S. Cl. CPC H04W 28/26; H04L 67/1097; H04W 8/22; H04L 41/0226

(57) ABSTRACT

A system for managing a network comprising at least one network slice instance including at least one network slice subnet instance. The system comprises a network slice management function associated with each network slice instance, the network slice management function configured to manage its associated network slice instance; and a network slice subnet management function associated with each network slice subnet instance, the network slice management function configured to manage its associated network slice subnet instance.

### CROSS REFERENCE TO RELATED APPLICATIONS

This application is based on, and claims benefit of, U.S. provisional patent application No. 62/491,852 filed Apr. 28, 2017 and U.S. provisional patent application No. 62/502481 filed May 5, 2017, the entire content of both of which is incorporated herein by reference.

### FIELD OF THE INVENTION

The present invention pertains to the field of Communications networks, and in particular to NSSMF NSMF interaction connecting virtual 5G networks and subnets.

### BACKGROUND

Network function virtualization (NFV) is a network architecture concept that uses the technologies of IT virtualization to create entire classes of virtualized network functions into building blocks that may be connected to each other or to other entities, or may be chained together, to create communication services. NFV relies upon, but differs from, traditional server-virtualization techniques, such as those used in enterprise IT. A virtualized network function (VNF) may consist of one or more virtual machines (VMs) running different software and processes, on top of standard high-volume servers, switches and storage devices, or even cloud computing infrastructure, instead of having custom hardware appliances for each network function. In other embodiments, a VNF may be provided without use of a Virtual Machine through the use of other virtualization techniques including the use of containers. In further embodiments, a customized hardware appliance may be resident within the physical infrastructure used for different virtual networks, and may be presented to each virtual network as a virtual version of itself based on a partitioning of the resources of the appliance between networks. For example, a virtual session border controller could be instantiated upon existing resources to protect a network domain without the typical cost and complexity of obtaining and installing physical network protection units. Other examples of VNFs include virtualized load balancers, firewalls, intrusion detection devices and WAN accelerators.

The NFV framework consists of three main components:
Virtualized network functions (VNFs) are software implementations of network functions that can be deployed on a network functions virtualization infrastructure (NFVI).
Network functions virtualization infrastructure (NFVI) is the totality of all hardware and software components that provide the resources upon which VNFs are deployed. The NFV infrastructure can span several locations. The network providing connectivity between these locations is considered as part of the NFV infrastructure.
Network functions virtualization MANagement and Orchestration (MANO) architectural framework (NFV-MANO Architectural Framework, for example the NFV-MANO defined by the European Telecommunications Standards Institute (ETSI), referred to as ETSI MANO or ETSI NFV-MANO) is the collection of all functional blocks, data repositories used by these blocks, and reference points and interfaces through which these functional blocks exchange information for the purpose of managing and orchestrating NFVI and VNFs.

The building block for both the NFVI and the NFV-MANO are the resources of an NFV platform. These resources may consist of virtual and physical processing and storage resources, virtualization software and may also include connectivity resources such as communication links between the data centers or nodes providing the physical processing and storage resources. In its NFV-MANO role the NFV platform consists of VNF and NFVI managers and virtualization software operating on a hardware platform. The NFV platform can be used to implement carrier-grade features used to manage and monitor the platform components, recover from failures and provide appropriate security—all required for the public carrier network.

Software-Defined Topology (SDT) is a networking technique that defines a logical network topology in a virtual network. Based on requirements of the service provided on the virtual network, and the underlying resources available, virtual functions and the logical links connecting the functions can be defined by an SDT controller, and this topology can then by instantiated for a given network service instance. For example, for a cloud based database service, an SDT may comprise logical links between a client and one or more instances of a database service. As the name implies, an SDT will typically be generated by an SDT controller which may itself be a virtualized entity in a different network or network slice. Logical topology determination is done by the SDT controller which generates a Network Service Infrastructure (NSI) descriptor (NSLD) as the output. It may use an existing template of an NSI and add parameter values to it to create the NSLD, or it may create a new template and define the composition of the NSI.

Software Defined Protocol (SDP) is a logical End-to End (E2E) technique that may be used within a network service instance. SDP allows for the generation of a customized protocol stack (which may be created using a set of available functional building blocks) that can be provided to different nodes or functions within the network, or network slice. The definition of a slice specific protocol may result in different nodes or functions within a network slice having defined procedures to carry out upon receipt of a type of packet. As the name implies, an SDP will typically be generated by one or more SDP controllers which may be virtualized functions instantiated upon a server.

Software-Defined Resource Allocation (SDRA) refers to the process of allocation of network resources for logical connections in the logical topology associated with a given service instance or network slice. In an environment in which the physical resources of a network are used to support a plurality of network slices, an SDRA controller will allocate the processing, storage and connectivity resources of the network to the different network slices to best accommodate the agreed upon service requirements for each of the network slices. This may result in a fixed allocation of resources, or it may result in an allocation that is dynamically changed to accommodate the different temporal distribution of traffic and processing requirements. As the name implies, an SDRA Controller will typically determine an allocation of resources, and may be implemented as a function that is instantiated upon a server.

Service Oriented Network Auto Creation (SONAC) is a technology that makes use of software-defined topology (SDT), software defined protocol (SDP), and software-defined resource allocation (SDRA) techniques to create a network or virtual network for a given network service instance. By coordinating the SDT, SDP, SDRA and in some embodiments Software Defined Network (SDN) control, optimization and further efficiencies can be obtained. In some cases, a SONAC controller may be used to create a network slice within which a 3rd Generation Partnership Project (3GPP) compliant network can be created using a virtualized infra-structure (e.g. VNFs and logical links) to provide a Virtual Network (VN) service. Those skilled in the art will appreciate that the resources allocated to the different VNFs and logical links may be controlled by the SDRA-type functionality of a SONAC controller, while the manner in which the VNFs are connected can be determined by the SDT-type functionality of the SONAC controller. The manner in which the VNFs process data packets may be defined by the SDP-type functionality of the SONAC controller. A SONAC controller may be used to optimize the Network Management, and so may also be considered to be a Network Management (NM) optimizer.

Network slicing refers to a technique for creating virtual networks which separate different types of network traffic, and which can be used in reconfigurable network architectures such as networks employing network function virtualization (NFV). A network slice (as defined in 3GPP TR 22.891 entitled “Study on New Services and Markets Technology Enablers,” Release 14, Version 1.2.0, Jan. 20, 2016, is composed of a collection of logical network functions that supports communication service requirements of particular use cases. More broadly, a network slice may be defined as a collection of one or more core bearers (or PDU sessions) which are grouped together for some arbitrary purpose. This collection may be based on any suitable criteria such as, for example, business aspects (e.g. customers of a specific Mobile Virtual Network Operator (MVNO)), Quality of Service (QoS) requirements (e.g. latency, minimum data rate, prioritization etc.); traffic parameters (e.g. Mobile Broadband (MBB), Machine Type Communication (MTC) etc.), or use case (e.g. machine-to-machine communication; Internet of Things (IoT), etc.).

As the implementation details and standards of NFV evolve, systems and methods for providing network slicing services and managing network slices that include one or more slice subnets in a consistent and reliable manner are highly desirable.

Within this disclosure, references to “traditional” or conventional networks, and a Traditional or conventional network management, should be understood to refer to networks and network management techniques that do not support slicing.

Within this disclosure, abbreviations that are not specifically defined herein should be interpreted in accordance with 3rd Generation Partnership Project (3GPP) Technical Standards, such as, for example, Technical Standard TS 23.501 V0.3.1 (March 2017).

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide systems and methods for managing network slices that include one or more slice subnets.

An object of embodiments of the present invention is to provide systems and methods for providing network slicing services to a customer.

Accordingly, an aspect of the present invention provides a system for managing a network comprising at least one network slice instance including at least one network slice subnet instance. The system comprises a network slice management function associated with each network slice instance, the network slice management function configured to manage its associated network slice instance; and a network slice subnet management function associated with each network slice subnet instance, the network slice management function configured to manage its associated network slice subnet instance.

Accordingly, an aspect of the present invention provides a system for managing a network comprising an Operator Domain. The system comprises a Communications Service Negotiation Function configured to interact with a customer to negotiate a network service level agreement; and interact with one or more management functions of the Operator Domain to reserve network resources for the negotiated service level agreement.

### BRIEF DESCRIPTION OF THE FIGURES

Further features and advantages of the present invention will become apparent from the following detailed description, taken in combination with the appended drawings, in which:

FIG. 1 is a block diagram of a computing system 100 that may be used for implementing devices and methods in accordance with representative embodiments of the present invention;

FIG. 2 is a block diagram schematically illustrating an architecture of a representative server usable in embodiments of the present invention;

FIG. 3 is a block diagram illustrating an example model for the management of resources;

FIG. 4 is a block diagram schematically illustrating a deployment of a Management system in an example embodiment;

FIG. 5 is a block diagram schematically illustrating interfaces between functional entities in an example embodiment; and

FIG. 6 is a message flow diagram schematically illustrating interactions between functional entities in an example embodiment.

FIG. 7 is a block diagram illustrating an example of E2E communication services provided by a sliced network;

FIG. 8 is a block diagram schematically illustrating an example of NSI as a service;

FIG. 9 is a block diagram schematically illustrating an example of NSSI as a service;

FIG. 10 is a block diagram schematically illustrating an example framework for interactions between the customer and network management functions in the operator domain;

FIG. 11 is a block diagram schematically illustrating a second example framework for interactions between the customer and network management functions in the operator domain;

FIG. 12 is a block diagram schematically illustrating a third example framework for interactions between the customer and network management functions in the operator domain;

FIG. 13 is a is a block diagram schematically illustrating a fourth example framework for interactions between the customer and network management functions in the operator domain;

FIG. 14 is a block diagram schematically illustrating an example framework for interactions between the customer and network management functions;

FIG. 15 is a block diagram schematically illustrating a framework utilizing an enhanced OSS/BSS deployed to act as the core of network management;

FIG. 16 is a block diagram schematically illustrating a framework in which CSNF is incorporated into the 5G Network Management System separately from the conventional NM;

FIG. 17 illustrates a framework in which the CSNF is configured to manage services over both conventional NM and the 5G NMS;

FIG. 18 is a table illustrating scenarios for interaction between 3GPP management functions and CSNF and OSS/BSS;

FIG. 19 is a block diagram schematically illustrating a scenario in which CSNF goes through CSNF and CSMF for all service types;

FIG. 20 is a block diagram schematically illustrating a scenario in which CSNF obtains direct services from NSMF and NSSMF for type B1 and B2 services;

FIG. 21 is a block diagram schematically illustrating a scenario in which Different services are managed by different MFs with NSMF managing conventional network management;

FIG. 22 is a block diagram schematically illustrating a scenario in which CSNF and CSMF are located in the Operator Domain (NM);

FIG. 23 is a block diagram schematically illustrating a scenario in which NM is in-charge of the overall network design; and

FIG. 24 is a block diagram schematically illustrating an alternative scenario in which NM is in-charge of the overall network design.

It will be noted that throughout the appended drawings, like features are identified by like reference numerals.

### DETAILED DESCRIPTION

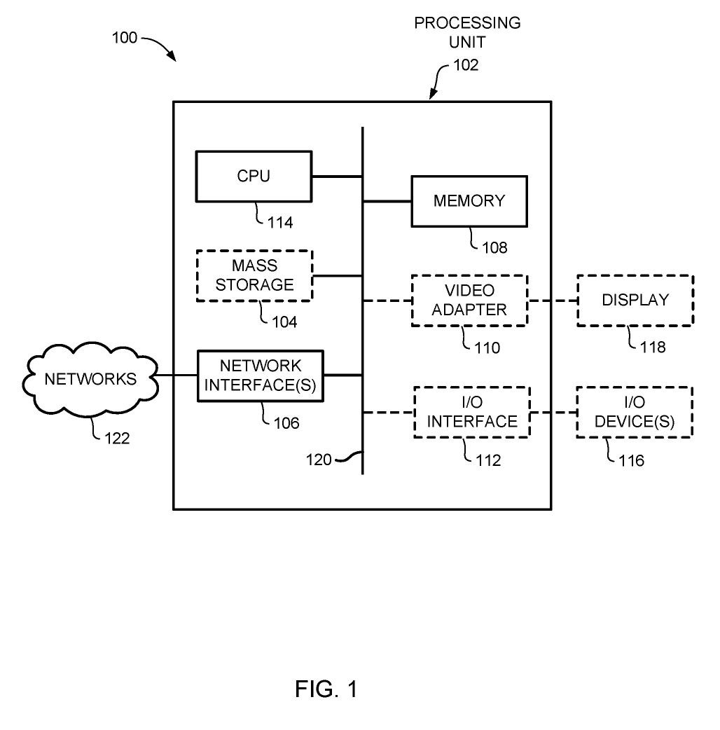

FIG. 1 is a block diagram of a computing system 100 that may be used for implementing the devices and methods disclosed herein. Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 100 includes a processing unit 102. The processing unit 102 typically includes a central processing unit (CPU) 114, a bus 120 and a memory 108, and may optionally also include a mass storage device 104, a video adapter 110, and an I/O interface 112(shown in dashed lines).

The CPU 114 may comprise any type of electronic data processor. The memory 108 may comprise any type of non-transitory system memory such as static random access memory (SRAM), dynamic random access memory (DRAM), synchronous DRAM (SDRAM), read-only memory (ROM), or a combination thereof. In an embodiment, the memory 108 may include ROM for use at boot-up, and DRAM for program and data storage for use while executing programs. The bus 120 may be one or more of any type of several bus architectures including a memory bus or memory controller, a peripheral bus, or a video bus.

The mass storage 104 may comprise any type of non-transitory storage device configured to store data, programs, and other information and to make the data, programs, and other information accessible via the bus 120. The mass storage 104 may comprise, for example, one or more of a solid state drive, hard disk drive, a magnetic disk drive, or an optical disk drive.

The video adapter 110 and the I/O interface 112 provide optional interfaces to couple external input and output devices to the processing unit 102. Examples of input and output devices include a display 118 coupled to the video adapter 110 and an I/O device 116 such as a touch-screen coupled to the I/O interface 112. Other devices may be coupled to the processing unit 102, and additional or fewer interfaces may be utilized. For example, a serial interface such as Universal Serial Bus (USB) (not shown) may be used to provide an interface for an external device.

The processing unit 102 may also include one or more network interfaces 106, which may comprise wired links, such as an Ethernet cable, and/or wireless links to access one or more networks 122. The network interfaces 106 allow the processing unit 102 to communicate with remote entities via the networks 122. For example, the network interfaces 106 may provide wireless communication via one or more transmitters/transmit antennas and one or more receivers/receive antennas. In an embodiment, the processing unit 102 is coupled to a local-area network or a wide-area network for data processing and communications with remote devices, such as other processing units, the Internet, or remote storage facilities.

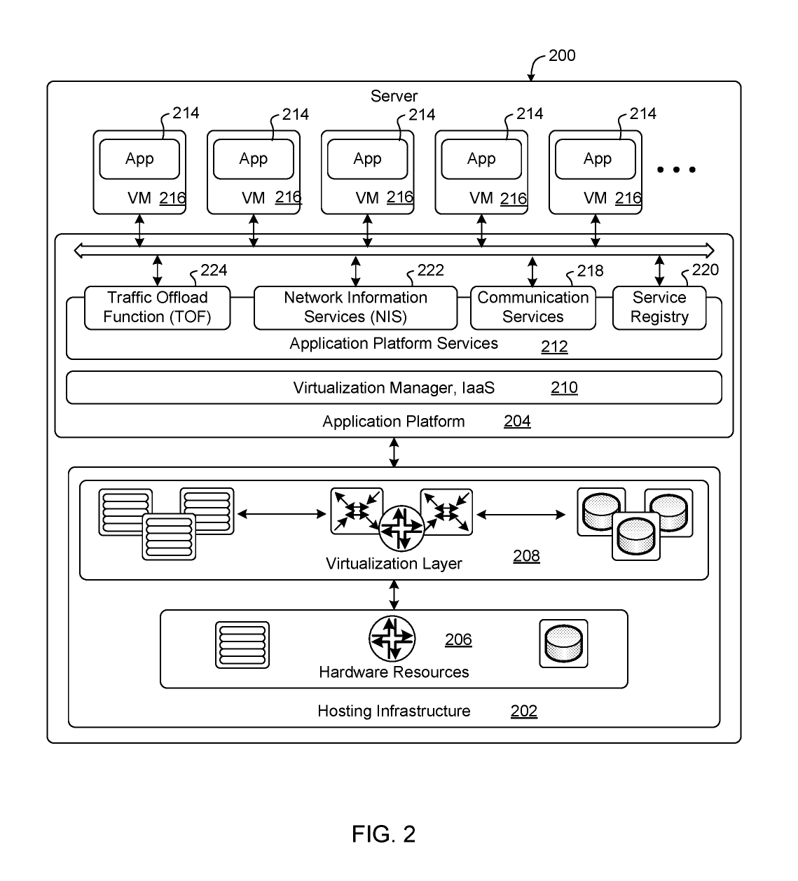

FIG. 2 is a block diagram schematically illustrating an architecture of a representative server 200 usable in embodiments of the present invention. It is contemplated that the server 200 may be physically implemented as one or more computers, storage devices and routers (any or all of which may be constructed in accordance with the system 100 described above with reference to FIG. 1) interconnected together to form a local network or cluster, and executing suitable software to perform its intended functions. Those of ordinary skill will recognize that there are many suitable combinations of hardware and software that may be used for the purposes of the present invention, which are either known in the art or may be developed in the future. For this reason, a figure showing the physical server hardware is not included in this specification. Rather, the block diagram of FIG. 2 shows a representative functional architecture of a server 200, it being understood that this functional architecture may be implemented using any suitable combination of hardware and software.

As maybe seen in FIG. 2, the illustrated server 200 generally comprises a hosting infrastructure 202 and an application platform 204. The hosting infrastructure 202 comprises the physical hardware resources 206 (such as, for example, information processing, traffic forwarding and data storage resources) of the server 200, and a virtualization layer 208 that presents an abstraction of the hardware resources 206 to the Application Platform 204. The specific details of this abstraction will depend on the requirements of the applications being hosted by the Application layer (described below). Thus, for example, an application that provides traffic forwarding functions may be presented with an abstraction of the hardware resources 206 that simplifies the implementation of traffic forwarding policies in one or more routers. Similarly, an application that provides data storage functions may be presented with an abstraction of the hardware resources 206 that facilitates the storage and retrieval of data (for example using Lightweight Directory Access Protocol—LDAP).

The application platform 204 provides the capabilities for hosting applications and includes a virtualization manager 210 and application platform services 212. The virtualization manager 210 supports a flexible and efficient multi-tenancy run-time and hosting environment for applications 214 by providing Infrastructure as a Service (IaaS) facilities. In operation, the virtualization manager 210 may provide a security and resource “sandbox” for each application being hosted by the platform 204. Each “sandbox” may be implemented as a Virtual Machine (VM) 216, or as a virtualized container, that may include an appropriate operating system and controlled access to (virtualized) hardware resources 206 of the server 200. The application-platform services 212 provide a set of middleware application services and infrastructure services to the applications 214 hosted on the application platform 204, as will be described in greater detail below.

Applications 214 from vendors, service providers, and third-parties may be deployed and executed within a respective Virtual Machine 216. For example, MANO and SONAC (and its various functions such as SDT, SDP, and SDRA) may be implemented by means of one or more applications 214 hosted on the application platform 204 as described above. Communication between applications 214 and services in the server 200 may conveniently be designed according to the principles of Service-Oriented Architecture (SOA) known in the art.

Communication services 218 may allow applications 214 hosted on a single server 200 to communicate with the application-platform services 212 (through pre-defined Application Programming Interfaces (APIs) for example) and with each other (for example through a service-specific API).

A Service registry 220 may provide visibility of the services available on the server 200. In addition, the service registry 220 may present service availability (e.g. status of the service) together with the related interfaces and versions. This may be used by applications 214 to discover and locate the end-points for the services they require, and to publish their own service end-point for other applications to use.

Mobile-edge Computing allows cloud application services to be hosted alongside mobile network elements, and also facilitates leveraging of the available real-time network and radio information. Network Information Services (NIS) 222 may provide applications 214 with low-level network information. For example, the information provided by MS 222 may be used by an application 214 to calculate and present high-level and meaningful data such as: cell-ID, location of the subscriber, cell load and throughput guidance.

A Traffic Off-Load Function (TOF) service 224 may prioritize traffic, and route selected, policy-based, user-data streams to and from applications 214. The TOF service 224 may be supplied to applications 224 in various ways, including: A Pass-through mode where (uplink and/or downlink) traffic is passed to an application 214 which can monitor, modify or shape it and then send it back to the original Packet Data Network (PDN) connection (e.g. 3GPP bearer); and an End-point mode where the traffic is terminated by the application 214 which acts as a server.

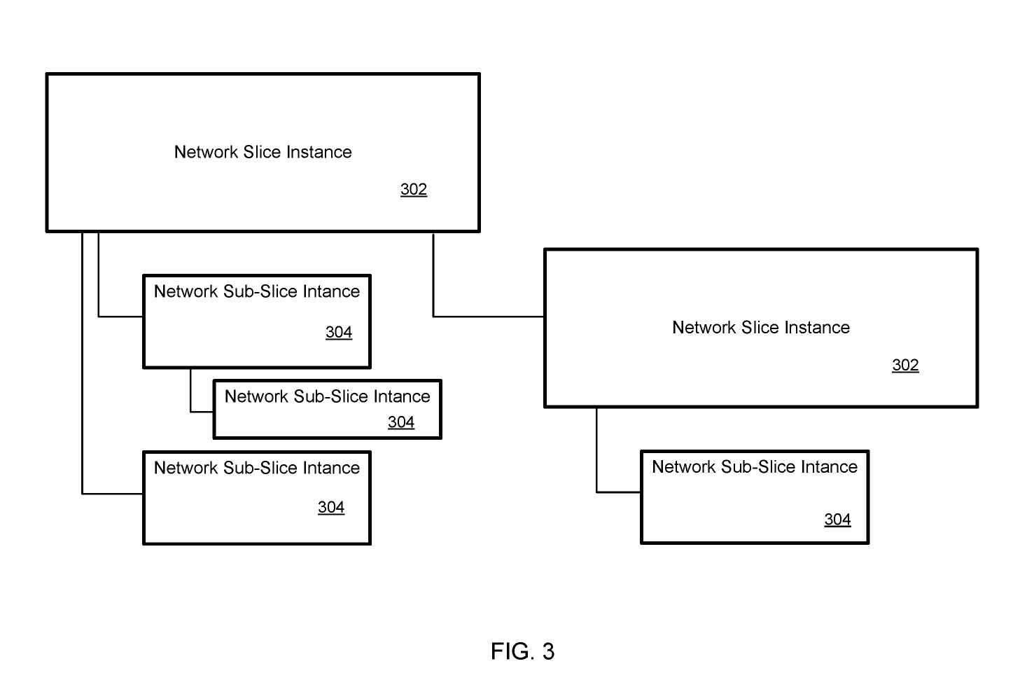

FIG. 3 illustrates a model for the management of resources. A 3GPP compliant Network Slice Instance (NSI) 302 is considered to have associated resources, and may incorporate a Network Subnet Slice Instance (NSSI) 304 with it. An NSSI 304 may be a core network slice, or it may be a RAN slice. Through aggregating the resources of the various NSSIs 304 within an NSI 302, it is possible to create an end-to-end network. Services requested from sub-domains may be provided as an NSSI 304.

By extending the 3GPP compliant model, an NSI 302 can incorporate another NSI (which may be composed of at least one NSI 302 and one or more NSSIs 304). This may result in redundant resources, for example more than one core network slice. This can be accommodated using, for example, a geographic or device type profile. This would allow a first core network slice having associated RAN slices to serve a first geographic area, for example, while a second core network slice having a different set of RAN slices may serve a second geographic area.

In embodiments where RANs are shared between different core network slices, the selection of a core network slice may be a function of the service to which an electronic device such as a UE is subscribed, or it may be a function of the type of UE connecting (e.g. machine type communication devices may be assigned to the second core slice).

The present invention provides systems and methods for managing network slices that include one or more slice subnets.

### Management Architecture Overview

The first goal of management is to ensure that the network is provisioned with the required resources for its proper functioning. In other words, a management layer monitors the network and scales it as needed. With the advent of anything as a service and virtualized network, infrastructure operators want to provide both a user plane connectivity to clients and a full network (user and control) and even network and management layer as services. Furthermore, it would be desirable to enable multiple parties to interconnect subnets to provide larger networks to the customer. For these reason, a number of interfaces can be standardized to support interoperation and inter optimization of these new network services.

### Notes on Virtualization

To explain the management and virtualization of a network, we start with the well-known virtualization of a computing platform:
1. a supervisor
2. virtual machines
3. resources

The resources are CPU cycles and memory allocation (and also peripherals/ . . . )

Then we have different forms or aspects of virtualization
(A) The supervisor has an overview of the resources and allocates them for use by the virtual machines.
(B) The virtual machines are isolated by the super-visor and run on the resources as if they were running on bare metal.
(C) Due to the nature of virtualization, it is possible to run one inside another, such that one virtualized machine can act as a supervisor to VM running on it.
(D) Eventually a simpler form of virtualization are containers. Containers do not offer access to all the control plane of the computing platform.
(E) An extension that virtualization can offer is linking together resources from different computing platform and presenting them as one unit to a virtual machine. This is something that high performance computing provides to processes that can run on multiple CPUs. Clusters of computers made of clusters of CPUs are perceived as one computation platform to the process running on this virtualized

### Definition of Virtual

As may be appreciated, the concept of “Virtual” is a one-way qualification, in that a virtual entity is only virtual to the one providing the entity (a computer, a network). It is not virtual to the one using it. That is to be understood that the fact that it is virtual makes no difference to the user of the virtualized object.

### Network Virtualization

The concepts described above can be compared to various levels of virtualizing a network.
A user plane network which is provided by virtualization by an operator is like a container as in (D) above.
A network with access to (some) control plane (e.g. switching tables or control VNF) compares to a VM, as in (B) above.
And a network offering access to a management level functional node is a full VM with supervisor capabilities, as in (C) above.
Finally, subnets can be ‘stitched’ together to form a bigger network, as in (E) above;
In any case, an operator first needs a top level supervisor entity, as in (A) above, to manage the virtualized network that it offers to customers. We can call this entity the hypervisor in opposition to the contained virtualized supervisors.

### High Level Architecture

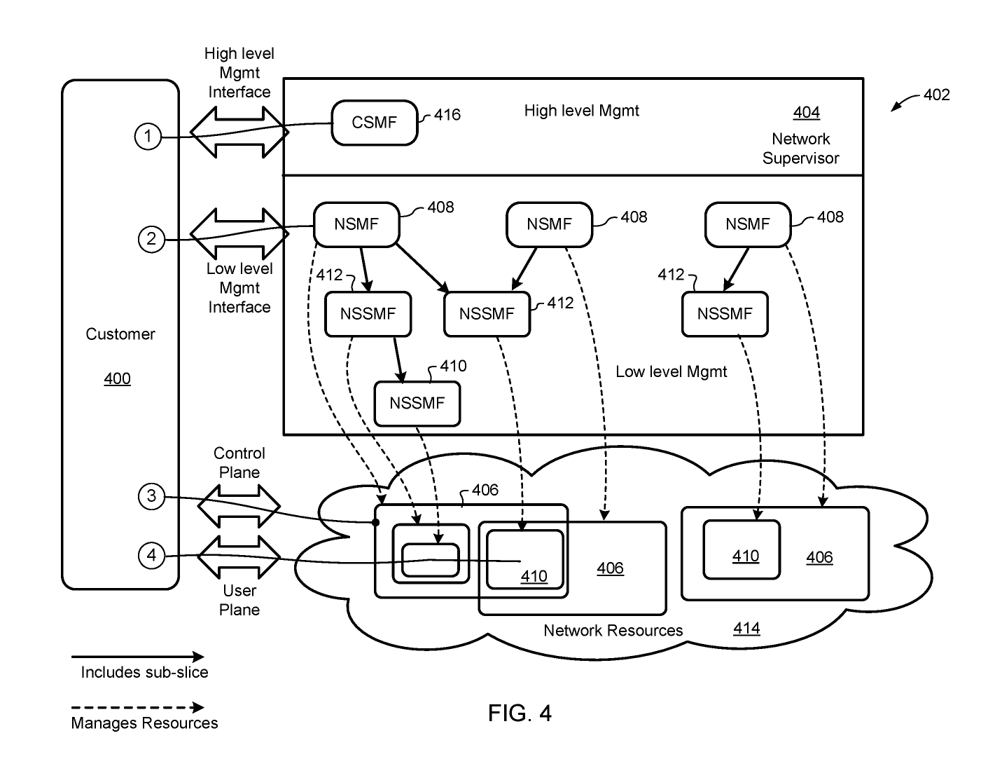

FIG. 4 illustrates an example network virtualization architecture. As may be seen in FIG. 4, a customer 400 is shown on the left and the provider 402 on the right. There is a hypervisor 404 which manages the infrastructure resources, ‘slices’ it and allocates resources to the various virtualized network resources and functions. It also is responsible to configure the Transport Network (TN) to ensure that networks elements are connected and isolated to form a virtual network.

Each network slice instance (NSI) 406 may be associated with a Network Slice Management Function (NSMF) 408, which is configured to manage the respective network slice. Similarly, a slice subnet instance (NSSI) 410 may be associated with a Network Slice Subnet Management Function (NSSMF) 412, which is configured to manage the respective network slice subnet. In the example of FIG. 4, three network slice instances 406 are shown (as represented by three NSMFs 408), although it will be appreciated that more or fewer network slice instances 406 may be instantiated as needed. In some embodiments, each NSMF 408 and NSSMF 412 may be analogous to a virtual machine with management as in (C) above, except that they provide network and computing virtualized service.

Physical network resources 414 may be sliced in a manner analogous to CPU or memory resource slicing by a supervisor on a computing platform. In the example of FIG. 4, the hypervisor 404 has access to the physical network resources and provides them to the virtual subnets.

An NSMF 408 and NSSMF 412 may incorporate resources from other slices or slice subnets, as illustrated by the solid arrows in FIG. 4. This may be accomplished by connecting (or configured to) to the respective NSMF 408 or NSSMF 412 of each involved slice or slice subnet.

In general, an NSSMF 412 or NSMF 408 is analogous to a VM running on sliced resources provided by the supervisor, as in (C) above. It provides a management interface for the sliced resources, in a manner analogous to an OS (virtualized to as a VM) which provides access to the sliced computing resources.

The supervisor may instantiate an NSSMF 412 or NSMF 408 for each sub-net or a complete virtualized network. An NSSMF 412 or NSMF 408 may have one logical interface (logically centralized, for example) with which a customer or the operator's hypervisor 404 may interact in order to configure it for the desired outcome. Finally, a top layer interface may be provided for customers to request “network as a service” to the operator. In some embodiments, four interfaces may be offered to the customer, namely: A high level management interface to request service; a low level management interface to manage a network/sub-net which can be partially or completely virtualized (in some embodiments, the customer may not see the virtualisation aspect); a control plane interface, which may include tunnels for separating the control plane from the user plane; and a user plane interface, which may access the data-network providing end to end communication.

### Architecture Details

### NSSMF 412/NSMF 408

An NSSMF 412 is a management entity that is created (instantiated/configured/ . . . ) in order to manage one Network Slice Subnet Instance (NSSI) 410. It is granted (by a supervisor) authorized access to various management procedures. For example, an NSSMF 412 may be authorized to scale its slice subnet by Requesting additional VNF or physical resource elements, or by connecting to another NSSI 410 to add the resources of that NSSI to its own NSSI 410. Similarly, an NSSMF 412 may be authorized to permit another NSSI 410 to use it as a resource (sharable resource), or to request another NSSI to incorporate it into its own NSSI. An NSSMF 412 may also be configured to accept inputs and/or generate outputs. Example Inputs/Outputs (IO) may include: User plane IO such as PGW or IP address to which to send packets to or receive from; UE access; Control plane IOs such as IP addresses through which control NFs of this sub-slice can be reached or through which control NFs of another sub-slice can be reached. An NSSMF 412 may also be authorized to share resources of its NSSI 410 with more than one other NSMF 408/NSSMF 412.

In some embodiments, there may be no functional difference between an NSMF 408 and an NSSMF 412 except for the conceptual distinction that an NSMF 408 provides all connected network functions to support a service. In some embodiments, an NSMF 408 may be the top functional node in a hierarchy of included NSSMF 412s in a virtual network.

The NSMF 408 may be configured by the network supervisor (i.e. the operator) to provide only the required management features, and force it to work within its own boundaries. For example, one NSMF 408 may be capable (configured and resources provided) of managing a pool of 100 VNFs and may ask the supervisor to increase its pool by 50 VNFs at a time at a given cost. A NSMF 408 may include resources from another NSSI 410. However, this relation may not be reciprocal, in that an included NSSI 410 may not include resources of its parent NSSI (since that would create a circular chain of resource inclusion).

### Hypervisor 404

A “network hypervisor 404” may be analogous to a supervisor OS running a virtualization computing platform and running directly on the platform hardware, except that in the present case the network hypervisor 404 supervises a whole network.

This supervisor instantiates other management logical functions such as NSMFs or NSSMFs. The point of these function is to expose NSIs and NSSIs while encapsulating (i.e. isolating) their management capabilities. In such a way, a customer which requires a network slice is provided with access to the NSMF 408 that has been instantiated for that slice. But the customer would not be able to request its (provided) NSMF 408 to use resources beyond the SLA.

### CSMF

In some embodiments, the Communication Service Management Function (CSMF) 416 may be the high layer language to communicate with the supervisor. The CSMF 416 may not be a logical function per se, but rather a service based interface. Implementations of CSMF 416 may interact with (or be part of) the operator's network supervisor to request the resources required to provide for services. The CSMF 416 may not interface (manage) NSMF 408/NSSMF 412, but it may reply to the customer via the service based interface, with NSMF 408/NSSMF 412 nodes (IP addresses to use to connect to them) that have been instantiated for the customer for it to use directly.

### Resources

Resources include the available physical resources to form a network, including switches and vSwitches, Data Centers, links, specialized hardware, etc. The hypervisor 404 may be able to set up a virtual network to interconnect nodes, instantiate VNF, set up routing tables, and authorize which part of which control entity can be controlled or managed by another.

### Interfaces

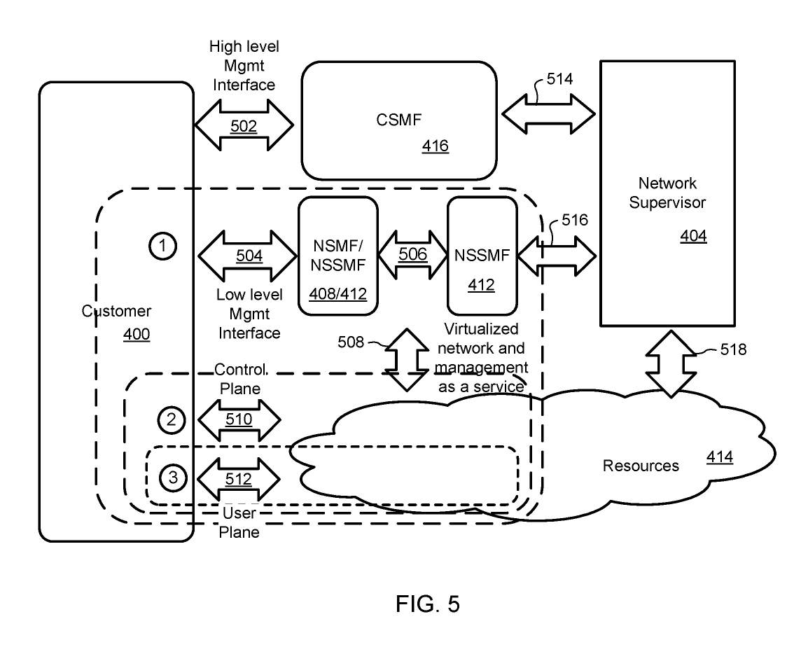

FIG. 5 illustrates example interfaces between the previously mention entities. The High Level Management Interface 502 enables a customer can make service requests to an operator. The Low Level Management Interface 504 enables a customer to manage a provided virtual network or slice that it has been provided as a service. An NSSMF or NSMF to NSSMF interface 506 enables one NSSI to be used by another NSSI. An NSSMF/NSMF interface 508 to the allocated resources may provide inter-operability when mixing VNFs/switches/vSwitches/Routers and element mangers of these.

Other interfaces may include a control plane interface 510 to isolate control from data, and access the control aspects of the provided network; a user plane interface 512 which may be provided at packet gateways to send (or receive) user data packets/flows; a CSMF-Hypervisor interface 514 to request the setup of virtual networks; a NSMF/NSSMF to hypervisor interface 516; and a hypervisor to resources interface 518.

The CSMF-Hypervisor interface 514 may be implementation dependent, and the CSMF 416 may be tightly coupled with the hypervisor 404. In specific embodiments, the CSMF 416 is not a functional node per se, but rather a language may be defined in order to express the service request to an operator, and automate such requests. Similarly, the NSMF/NSSMF to hypervisor interface 516 and the hypervisor to resources interface 518 may be implementation specific.

The architecture illustrated in FIG. 5 may enable three types of service to be provided to a customer, namely: a user-plane network (or a slice without any control or management function); a full slice with no management (for example, it cannot scale or adapt on direct demand of the customer); and a full slice and management.

In the later service, the customer may continue to compose larger networks by bridging its own slice(s) to the exposed NSMF 408 provided function(s)

### Procedures Over the Interfaces

### High Level CSMF

Requests service type:
   eMBB, phone/short messaging/broadcast/URLLC/
   coverage
   number of UE/max density/probability of connection
   radio access technology, bandwidth, end-to-end latency, guaranteed/non-guaranteed QoS,
   security level, isolation type
   output:
      error messages for incompatible parameters (e.g. insufficient radio tech for service demand, no/insufficient available coverage)
      one or many slices, connectivity parameters (access to HSS database to add UEs)
      no management plane
Request slice with management: a slice request comes with a more or less detailed requirements for the slice. This includes
   Which NF/SFC
      Requirement between NF latency/throughput
      NF types, Requirements of NF processing power/memory/availability
   Capacity of NF input
      Max Number of simultaneous sessions
      Sessions types/throughput/latency budget
      e.g. an AMF should handle 10000 session arrival per minute
         a UPF should handle 100 Mbit/s session
      Availability of NFs (VNFs)
         How many VNFs can be required at peak time (defines the pool of NF)
         e.g. all “available” UPF in region Y should provide for 100 sessions at a time.
         How fast is it required to ramp up
         e.g. max arrival rate of sessions is 10/s
            (defines how fast VNFs need to be instantiated or be made available)
      Location of NFs
         Define MEC location/central Data Center (DC) location
      Output:
         Slice with management interface to
            request activation or start of one end to end connection.
            ramping up/ramping down functions
            obtain feedback on current loading (VNFs usage/percentage usage of VNF pools/remaining allocable capacity where capacity is related to the potential VNF activation to support more sessions)
               Low Level a.k.a. Slice Management Interface NSMF/NSSMF
NSMF/NSSMF interface 506
To customer (east bound):
   Overload and need to request more resources
   Input to accept or cancel or authorize scaling up to a threshold
   Request inclusion into the customer's own NSMF 408
   Any authorised west bound interface
To supervisor (north bound)
   This includes the previous signaling to customer and Receive authorisation to expose procedures and feedback to east bound
      Reset
      Provide new layer 2 parameters
      Request/Receive new resources
      Discard/Remove old resources
      Receive configuration and authorisation of other NSSMF 412 it can talk to (include or be included)
To network resources (south bound)
   Activate/deactivate/discard/release
   Setup TN parameters
   Configure bridges (to link to other NSSI)
To other NSSI (west bound)
   Expose/request capability for
      The list includes the list of available NFs types,
      Pools of these NF types (virtualized or not), their capacity or availability number of each NFs types
      A maximum authorized range to request extension of these pools
      The capacity of each NFs types. E.g.
   Max Number of simultaneous sessions
   Sessions types/throughput/latency budget
      e.g. an AMF should handle 10000 session arrival per minute/a UPF should handle 100 Mbit/s session
Availability of NFs (VNFs)
   How many VNFs can be required at peak time (defines the pool of NF)
   e.g. all “available” UPF in region Y should provide for 100 sessions at a time.
   How fast is it required to ramp up
   e.g. max arrival rate of sessions is 10/s
(defines how fast VNFs need to be instantiated or be made available)
   Location of NFs
      Define MEC location/central DC location
The capacities to link each NF within each location and across locations
   E.g. within DC region 1, NFs can be provided QoS Y for interconnect
   Between DC region 1 and MEC 2, QoS Z can be supported
The type of provided resources allocation for each type of pools:
   guaranteed resources availability (either by hard slicing or soft with guarantee)
   authorized but not guaranteed, (soft slicing but potentially overbooked)
      Claim a resource
      Release a resource Internal procedure or cross NSSMF 412/NSMF 408
      Relocate/Migrate VNFs, e.g. moving a UPF from remote to local

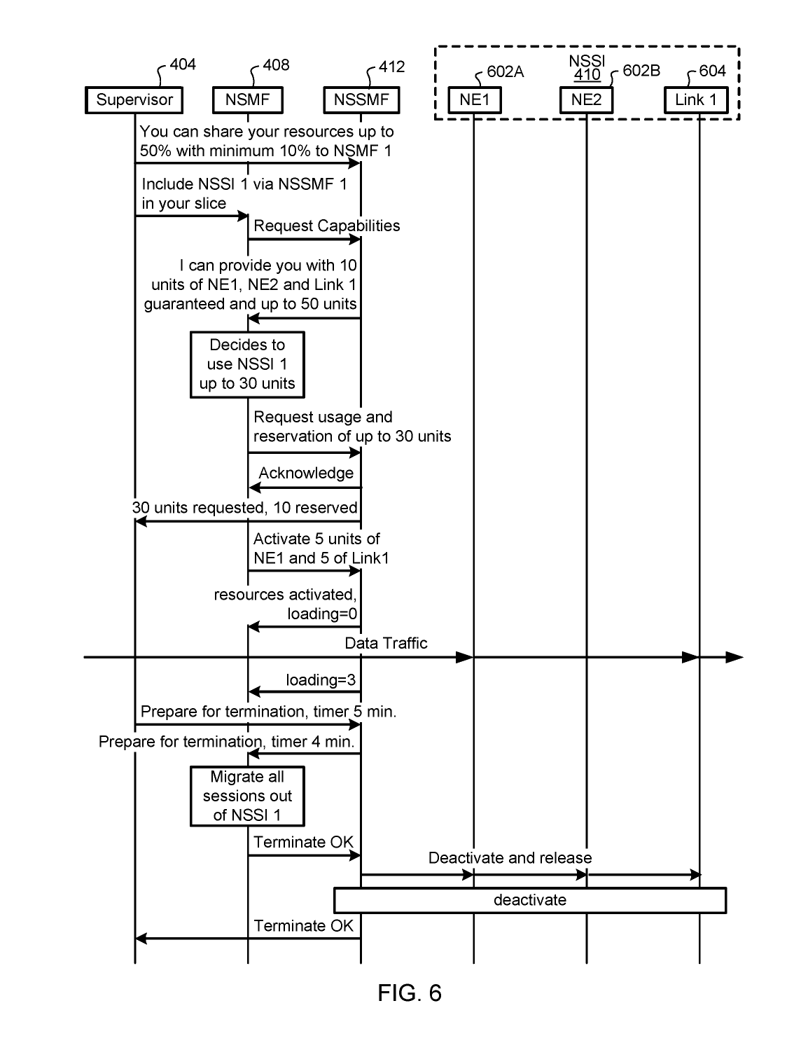

FIG. 6 is a call flow diagram illustration example interactions between a supervisor, and NSMF 408 and an NSSMF 412. NSSMF 412 to NSMF 408 interactions may be classified into several parts, as follows:
1. Time zero: NSSMF 412 provide all its capability, topology or management and control plane access info. (e.g. all the resources it has, links computing capabilities, etc.). This is for different openness levels as in the contribution. This includes alarm tracking facilities, security aspects, performance monitoring facilities, data caching facilities, etc.
2. When the NSMF 408 requests to use a NSSI from the NSSMF 412: The NSMF 408 may provide current sharable NSSI information, current sharable NF information, and the available resources (if committed for certain durations with that information). It may not divulge the information about other NSMFs (NSI's) sharing its NSSIs unless it is the same NSMF 408—only the remaining non-committed resources.
3. During the run time: (NSI is active and running and so the NSSI). (a) Performance feedback should be given. (b) Any infra-structure or resource availability change; (c) any request for using more resources based on demand, etc.
4. When terminating a NSI: The NSSMF 412 need to terminate the NSSIs and NFs if they are not shared by others and update the available resources to other NSMF 408s who use this NSSMF 412

### Capabilities of NSSI

An NSSMF 412 manages a sub-net. This includes a pool of resources, some may be virtualized in a data center (DC), and malleable (i.e. can be migrated to different virtualization infrastructure, read local/remote DC), and some may be physical resources in a fixed physical location.

Hard Resources include: storage (short term RAM/medium term SSD/HDD/long term robotized high density storage); computing capabilities (CPUs and associated caches); and link/interconnect capabilities (latency and capacity and supported maximum simultaneous connections). These resources can be described in a structure of clusters, reclusively (tree format possibly expressed in the form of an XML file or ASN.1 format); each cluster providing the above resources details and higher layer interconnect/link capabilities across clusters. Clusters of clusters can be expressed.

Soft Resources include: VNF or NF types; Availabilities of these VNFs and NFs; Capabilities to instantiate any or claim their usage; Size of pools, maximum size of pools, guaranteed minimum available resources; Capabilities of NF/VNFs of handling X simultaneous sessions of Y throughput, or peak/average processing capabilities; Capabilities of logical links that can be established between NFs (and VNFs); and Requirements each VNFs may have such as expected cost of activating or using one NF/VNF, required latency between two NF types and consumed capacity between two NF/VNFs

An NSSMF 412 also exposes interconnect or bridge capabilities to external networks. For example it may advertise being capable of connecting to known physical data centers with certain capabilities from which a second NSSMF 412/NSMF 408 can deduce that given its own resource's location, it may request a bridge connection to the first NSSMF 412.

### Sharing and Policy

All the above information elements can be shared based on sharing policies. An NSSMF 412 may be configured with a set of policies by a supervisor entity. Those policies may include: Who can request access to the NSSI managed; How the NSSI can be shared by two or more other NSSMF 412(s); Hard sliced resources or soft slice resources; Minimum guaranteed and/or maximum usable by requesting NSSMF 412; and how much it can expose and to whom (other NSSMF 412/NSMF 408).

### NSMF 408/NSSMF 412 Difference

An NSMF 408 and its NSI is similar to an NSSMF 412/NSSI, but with specific capabilities/parameters/status/or limitations. For example, an NSI may be a non-sharable network that cannot be included by another NSI. An NSI may be a network that provides all the connectivity required for a given service or a given customer.

### Capability Request

An NSSMF 412 can reply to an NSMF 408/NSSMF 412 when receiving a query for capabilities. The query may request a listing of all available capabilities, or it may request information about a particular capability.

The NSSMF 412 may reply according to its configured policy with a list of capabilities that it can expose to the requesting NSMF 408.

The NSMF 408 may send the query with a certificated or integrity field that can be verified by the NSSMF 412 for it to authenticate that it is the NSMF 408 it pretends to be, in order to generate a reply that complies with its configured policy.

### Direct Management Request

A parent NSMF 408 (or NSSMF 412) may directly request (if authorized for this) to manage the lifecycle of functions under the scope of the children NSSI/NSSMF 412. The parent may request instantiating new VNFs in order to offload some of its traffic or to handover sessions. Alternatively the children NSSMF 412 may apply the management itself (scaling the NF) according to the current demand and the policies it has been configured with. Management policy may be provided by the supervisor for how it can share resources or by the parent on how to scale. A need or a request for the NSSMF 412 to scale up (or down) by activating more resources, may trigger it, given configured policy to request increasing pool sizes of given NF types to the supervisor.

### Monitoring Signaling

During usage, of the underlying NSSI an NSSMF 412 can report monitoring values related to each individual or group of resources. An NSMF 408 may request a monitoring message to be fed back provided a given threshold of loading of a particular or of any parameters of one type. During the active time of an NSSMF 412, different traffic engineering and SDT optimization may happen inside one or across DC one NSSMF 412 manages. This may lead to changes in loading of either computing/storage or interconnection links. As well, changing demands of the customers and clients using the underlying NSSI or changes of demand from parent NSI using the NSSI may change the loading status. All these cases may trigger the NSSMF 412 to send monitoring status as the loading changes. Monitoring can be reported in individualized (per network element) or summarized/digested reports. For example, loading can provide information of one whole DC and may be sufficient for the direct user (parent NSI/customer) to know how many more instance or sessions it can start. Alternatively, loading can be provided on clusters of elements. For example separating loading of various physical functions from each type and from virtual functions that can be instantiated on demand until the underlying commodity hardware is fully loaded. Monitoring threshold can be based on the management status of the children NSSMF 412. That is, if the children are configured to scale automatically given experienced demand, the monitoring message may be fed back when the scaling reaches a given threshold.

### Migration

An NSSMF 412 may receive commands to migrate VNFs across its own network resources, e.g. from one local resources cluster (Mobile Edge Computing) to a remote one (Data Center). Or it may request a migration form its own NSSI out to the parent NSMF 408, which will receive it and instantiate it on any of its own resources or other children NSSI.

### Termination

An NSSMF 412 may receive a termination message from (one of, if shared) its parent NSMF 408, whereby the NSMF 408 will release all associated resources to that NSMF 408 and terminate the sharing.

An NSSMF 412 may receive a termination message from its supervisor and will in turn inform all parents to migrate/offload all processes and sessions, in order to free the NSSI. Then each parent can reply with the termination message.

Timers may be associated with the above process, whereby, if the parent has not replied in time with a termination signal, and the NSSMF 412 monitors no traffic or loading, it may force the release of the resources. It may send warning signaling to the parent NSMF 408s/customer/ supervisor, before starting another timer or continuing with the termination process. If traffic or loading is observed, additional steps may be required, to inform the customers and the supervisor, before further hard termination steps are taken.

### Further Information Element Exposed

Types of subnets
   RAN
      Dense deployment
      Rural
      Local (e.g. stadium)
      Indoor/outdoor
   Core
      Local (MEC) functionalities
      Remote DC
   Mixed
      Core and RAN integrated slice subnets
   Pure control plane subnets
      Only includes 3gpp control nodes (AMF/SMF/MME/)
      Includes any control network function
   Pure user plane subnets
      UPF/PGW/RAN User plane
   Predefined service type slice
      E.g. RAN covering a given city area for eMBB nomadic usage (e.g. WLAN deployment), or a MCPTT service interconnecting only mobile UEs in a given geographical region
Types of RATs (for subnets including RAN nodes)
   4g/5g RAN
   Home AN (home eNB or gNB)
   WLAN subnet (stadium/airport/city parks or internet coffee)
   5G Home internet WLAN end points and mmWave last mile
   Computing MEC
   Storage MEC
   Relay
   mmWave backhaul/fronthaul
types of RAN capabilities exposed (for RAN nodes)
   coverage map (of signal strength or expected capacity with no other loading)
   coverage radius
   coverage radios outdoor/radius indoor
   bin mapping, and multidimensional bins (mixing loading of neighbor interference)
   max simultaneous UE connectivity
   max sum throughout
   max sum throughput per connection and per RAT parameters (category of UE/MIMO layer/modulation supported/ . . . )
   Bandwidth and bandwidth sharing, hard slicing capabilities
   Max power
   Interference map
   Beamforming capabilities,
      Capability to generate a cell and scale it or capability to generate a beam and steer it to follow moving objects
   Classes of UE supported (category 1 to 20, M1, M2)
Types of service or QoS supported:
   Type of service such as enhanced mobile broadband, Multimedia Broadcast Multicast Service, Push to talk, Single frequency network, ultra-reliable and or low latency, IoT service (Narrow band IoT), and mission critical push to talk services.
   Type of 5G QoS channel indicator supported (type A index or type B and definition), latency budget supported, packet loss rate supported, capacity supported, aggregated or per session or QoS-flow. 4G QoS class, DiffSery supported differentiation.
types of RAN monitoring exposed (over given time window)
   Loading, in bandwidth
   Number of active user
   Statistics of active users (SNRs/signal strength/SE, in a given time window, used resources/transferred data amounts/peak rates/average rates/locations)
   Types of users (users active for different services e.g. NBIoT, URLLC, eMBB, . . . )
   Statistics of users connected to different slices or gateways
And Core monitoring parameters (over given time window)
   Number of active sessions/NF loading/link loading

For nodes that are shared (for two or more NSI), either the node itself can report on a per shared partition or the NSSMF 412 should digest and estimate what shared portion each parent slice uses. Entities can also provide a list of configurable parameter list (parameters that can be configured by a control plane). The NSSMF 412 may expose these to the parent slice depending on policy configuration. Furthermore, template subnets may be defined such that the message exposing capabilities from the NSSMF 412 to the NSMF 408 results in a simple “subnet of type X with capacity Y”. For example, a subnet of 5G control plane function to handle 500k active PDU sessions. Alternatively, subnet of type 5G gNB covering city of Ottawa may handle 500k connected users and 100k active users.

To provide network slicing services, a variety of interactions and network management functions are involved. Different service types of network slicing may request different management functions. Thus, it is necessary to define interfaces, relationships, involved management functions, and different options. In this disclosure, to realize the interaction between the customer and the operator in different service types, several frameworks are described to define the interaction between the customer and network management functions in the operator domain.

The following paragraphs discuss various management functions (CSMF, NSMF 408, NSSMF 412) involvement in different types of Persona (business entities) providing different types of services (e.g. service instance, NSI as a service, NSSI as a service). The following subsections explains these classifications in detail.

### Management Functions for E2E Communication Services Provided by a Sliced Network

When a customer requires an End-to-End (E2E) communication services, the network provider has to use an E2E network slice and ensure the E2E performance. In this case the network provider takes the role of a Customer Slice Provider (CSP). The Communications Service Management Function (CSMF) will provide the NSMF 408 with network slice requirements that corresponds to the service requirements. The service instance is the internal 3GPP representation of the service provided using the NSI. There can be multiple service instances served using the same NSI. It may be noted that sharable Ne Functions (NFs) are identified by NSMF 408 and NSSMF 412.

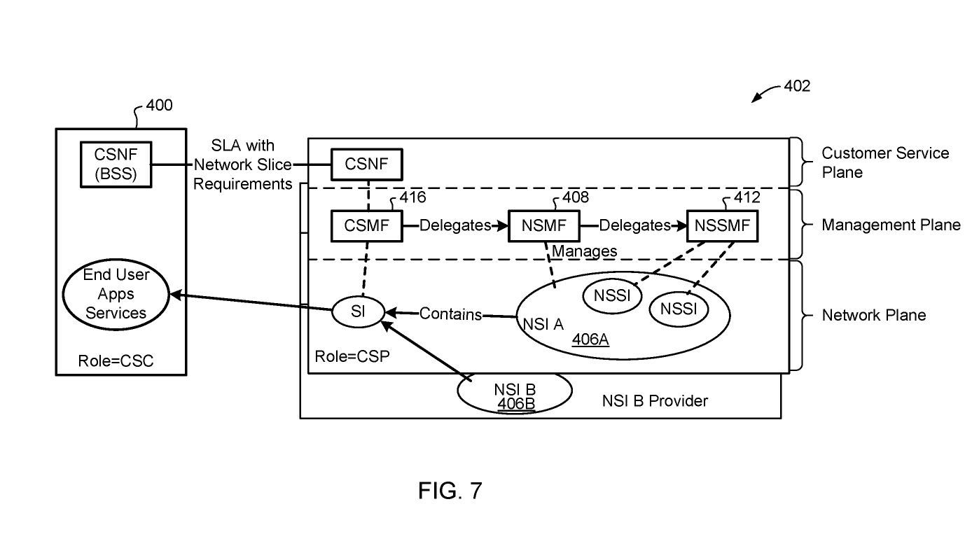

FIG. 7 shows an example of E2E communication services provided by a sliced network. In this case, the network slice management is fully hidden to customers (E2E customer) by CSP in an E2E slicing service. Service request and related service negotiations and service related information including feedback and service request modification happens between the customer and the CSMF.

### Management Functions Involved in Providing NSI as a Service

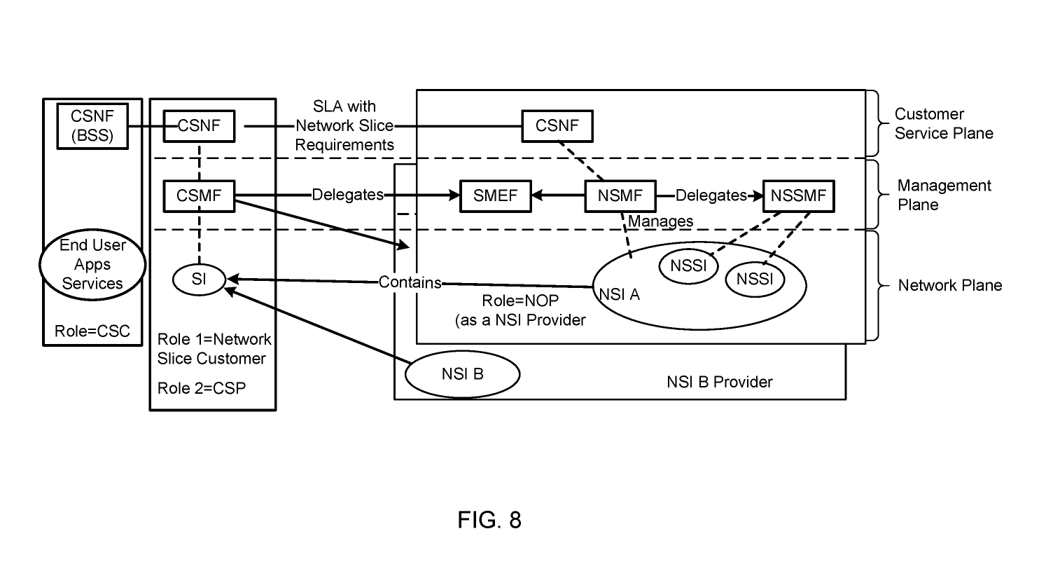

FIG. 8 shows the involvement of the management functions in providing an NSI as a service. The customer can be provided with limited network management capabilities by exposing certain management functions of the NSMF 408 as through a Slice Management Exposure Function (SMEF).

The service request and related service negotiation happens initially between the customer and the CSMF. However, after the Service Level Agreement (SLA) is established, the network provider may provide authorized access to certain NSMF 408 functions so that the customer can use the NSI for its communication services.

NOTE: How much is exposed is determined by the operator and captured in the SLA since some of the management functionality may be handled by the Network Operator (NOP), for example CM and FM may be done by NOP and PM may be done by the customer.

### Management Functions Involved in Providing NSSI as a Service

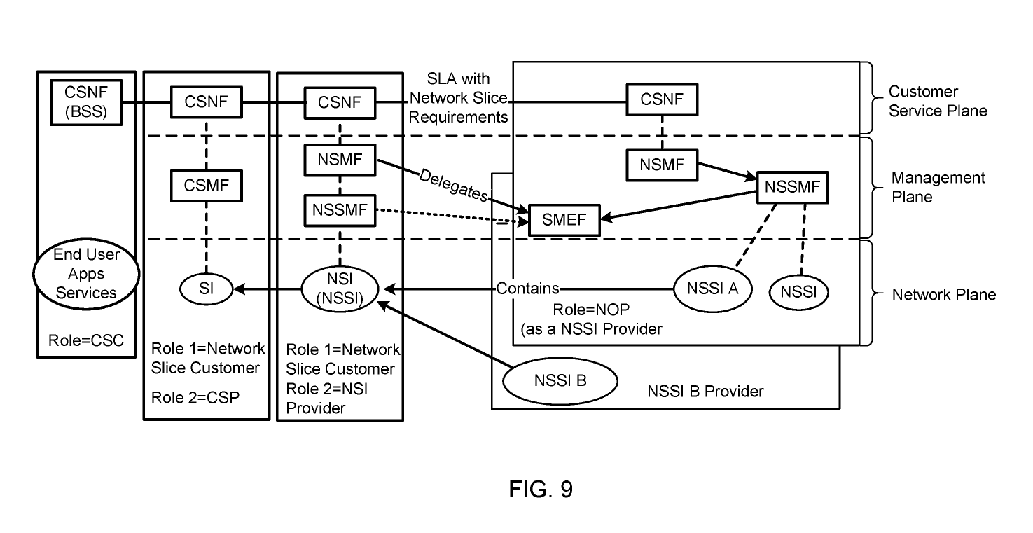

FIG. 9 shows the involvement of the management functions in providing an NSSI as a service. As in the example of FIG. 8, the customer can be provided with limited network management capabilities by exposing certain management functions of the NSMF 408 and NSSMF 412 through a Slice Management Exposure Function (SMEF).

The service request and related service negotiation may happen initially between the customer and the CSMF. However, after the SLA is established, the network provider may provide authorized access to certain NSSMF 412 functions so that the customer can use the NSSI for its communication purposes. It may be appreciated that if this NSSI is requested by another NSSMF 412, the NSSMF 412 needs to be involved. This is described in further detail below.

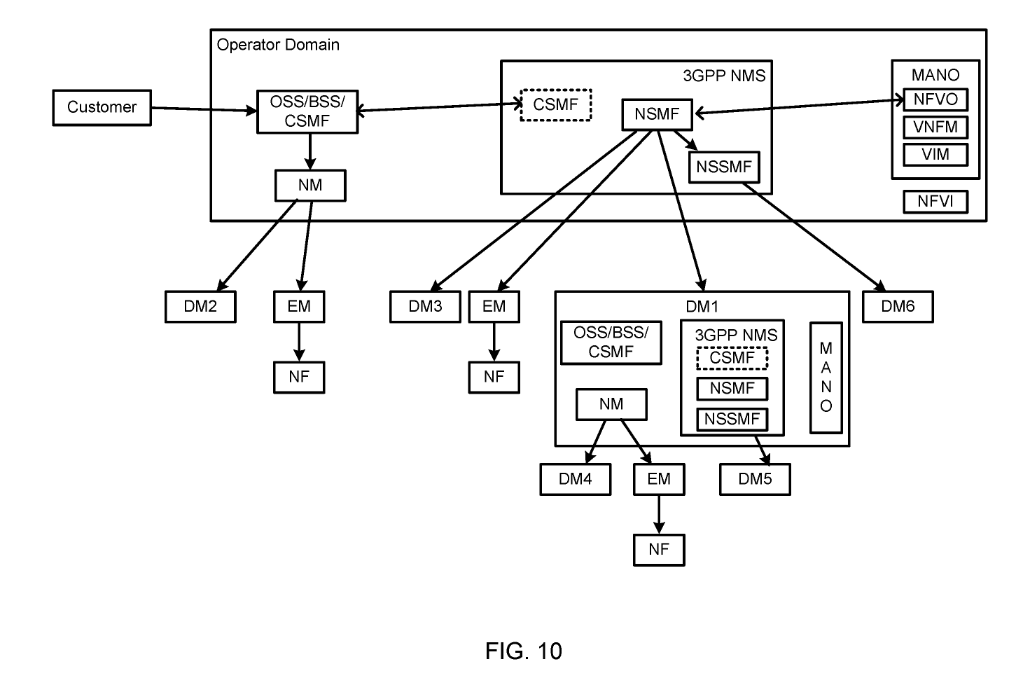

FIGS. 10-12 illustrate example frameworks in which an SNF/CSNF is not used for negotiation of an SLA. In these embodiments, customer negotiations are handled by the CSMF.

FIG. 10 is a block diagram schematically illustrating an example framework for interactions between the customer and network management functions in the operator domain. In the example of FIG. 10, the customer interacts primarily with a CSMF (for example an Operational Support System (OSS)/Business Support System (BSS)) in the Operator Domain for service negotiation. In this case, the CSMF may then interact with a network manager function in the Operator Domain to reserve resources for a negotiated SLA in one or more domains (such as DM2) or network functions (NFs, for example via one or more element managers (EMs)). The CSMF may also interact with a 3GPP complaint Network Management System (NMS), for example by means of a counterpart CSMF of the 3GPP NMS, in order to reserve resources of one or more domains, slices and slice subnets subtending the 3GPP NMS. If needed, the 3GPP NMS may also interact (for example via an NSMF 408 of the 3GPP NMS) with a Management and Orchestration (MANO) function for this same purpose.

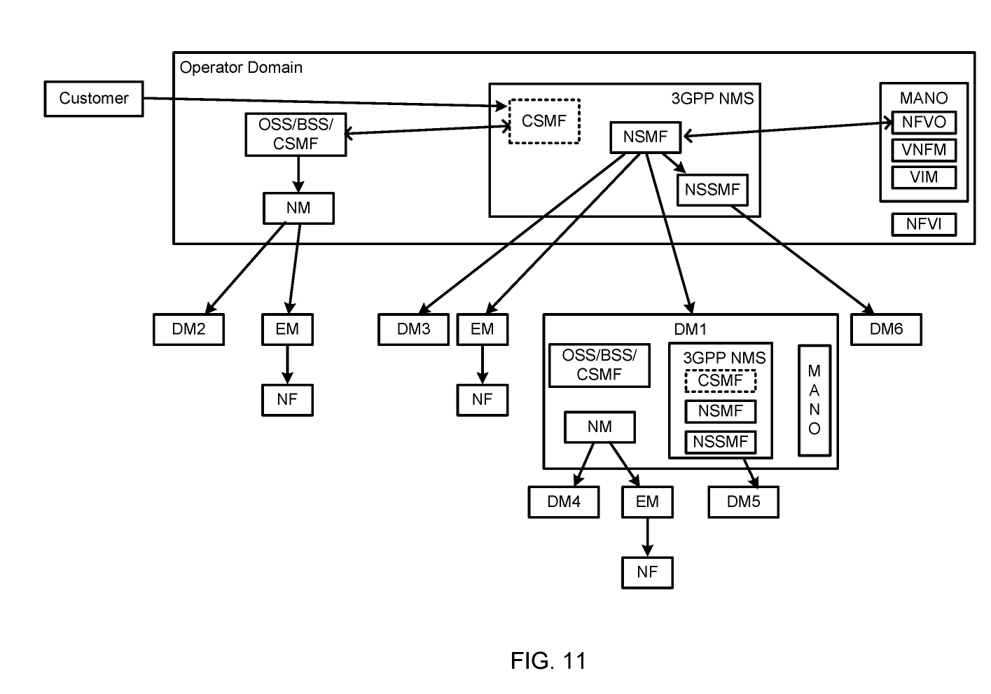

FIG. 11 is a block diagram schematically illustrating a second example framework for interactions between the customer and network management functions in the operator domain. In the example of FIG. 11, the customer interacts primarily with a CSMF (for example an OSS/BSS) in the 3GPP complaint Network Management System (NMS) for service negotiation. The CSMF of the 3GPP NMS may then interact with NSMF 408(s) and NSSMF 412(s) of the 3GPP NMS to reserve resources of one or more domains, slices and slice subnets subtending the 3GPP NMS for a negotiated SLA. The CSMF of the 3GPP NMS may also interact with a CSMF (for example an OSS/BSS) in the Operator Domain to reserve resources of one or more domains (such as DM2) or network functions (NFs, for example via one or more element managers (EMs)) subtending the Operator Domain to support the negotiated SLA. If needed, the 3GPP NMS may also interact (for example via an NSMF 408 of the 3GPP NMS) with a MANO function for his same purpose.

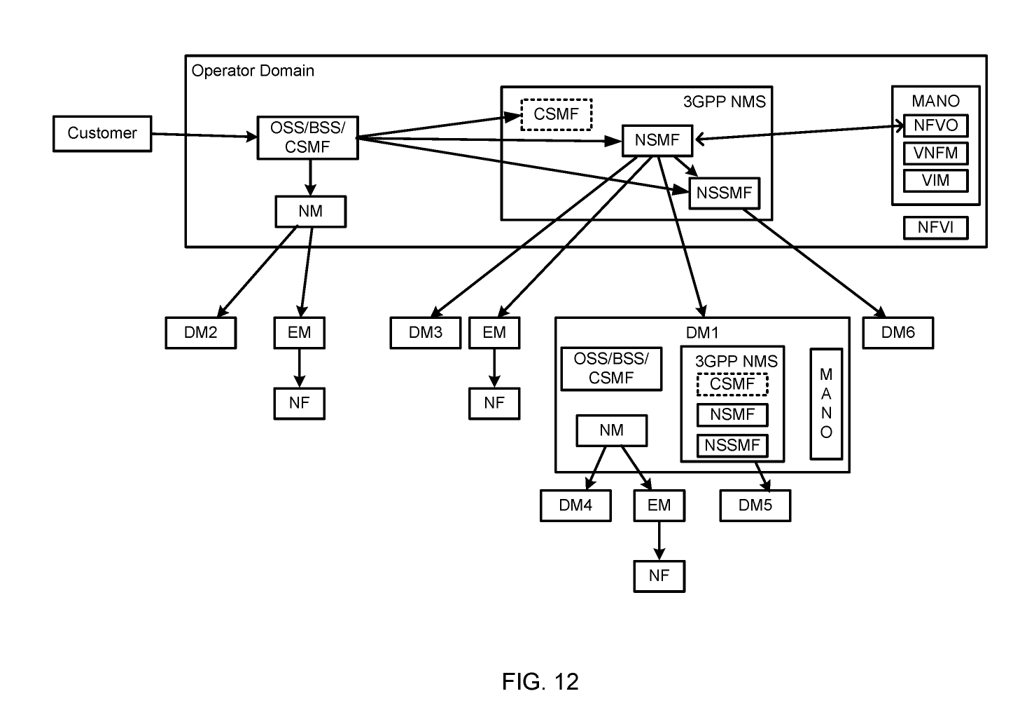

FIG. 12 is a block diagram schematically illustrating a third example framework for interactions between the customer and network management functions in the operator domain. The example of FIG. 12 is similar to that of FIG. 10, except that in this case, interfaces are provided that enable the CSMF in the Operator domain to interact directly with any of the CSMF, NSMF 408 and NSSMF 412 entities in he Operator's 3GPP NMS.

Network operator's management system includes a 3GPP management system to incorporate 3GPP services and also ETSI MANO to manage and orchestrate the virtualized functions and resources. The operator may use other network segments such as the data networks or cloud networks where the application servers reside and transport networks (TN) used for various connectivity requirements. (In this discussion, we assume the management of the TN is done by an entity called Transport network manager (TNM).) In particular, it is important to have a clear view of how a network operator would use the 3GPP management system and how the 3GPP management system would use the ETSI MANO for virtual function and infra-structure management and orchestration.

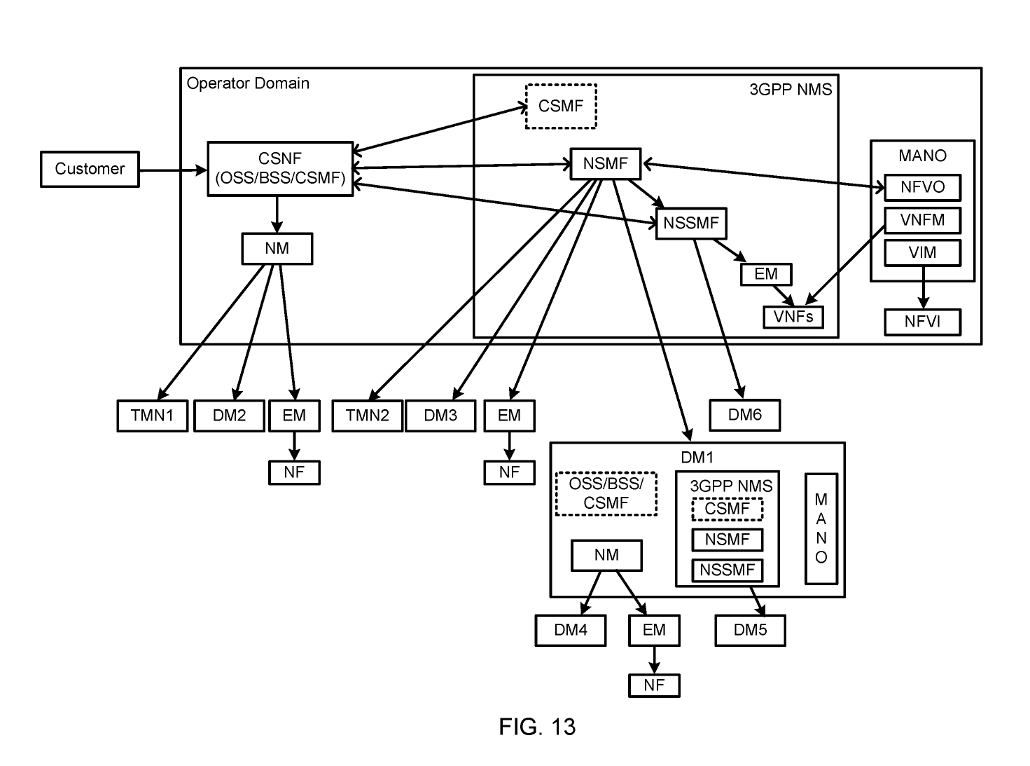

Thus, the following discussion with reference to FIGS. 13-24 describes how these management functions may be coordinated in order to ensure the provision of a communication service by the network operator to the satisfaction of the customer. A generic management framework is discussed, through which various management entities including both 3GPP and non-3GPP may be coordinated in order to ensure the provision of a communication service by the network operator to the satisfaction of the customer.

The following subsections explains these classifications in detail.

### 3GPP Management Functionality if Customer Service Negotiation Function (SNF) is in a Non-3GPP Domain

FIG. 13 is a block diagram schematically illustrating an example framework for interactions between the customer and network management functions, in a scenario in which the customer service negotiation function (SNF) is in a non-3GPP domain. In the example of FIG. 13, the customer interacts primarily with the SNF (which may, for example, incorporate the functionality of an OSS/BSS) in the Operator Domain for service negotiation. In this case, the SNF may then interact with a network manager function in the Operator Domain to reserve resources for a negotiated SLA in one or more domains (such as DM2), Transport Networks (as represented by TNM 1), or Network Functions (NFs, for example via one or more element managers (EMs)). The SNF may also interact with a 3GPP compliant Network Management System (NMS), for example by means of a CSMF, an NSMF 408 or an NSSMF 412 of the 3GPP NMS, in order to reserve resources of one or more domains, slices and slice subnets subtending the 3GPP NMS. If needed, the 3GPP NMS may also interact (for example via an NSMF 408 of the 3GPP NMS) with a MANO function for this same purpose.

### 3GPP Management Functionality if Customer Service Negotiation Function (SNF) is in 3GPP Domain

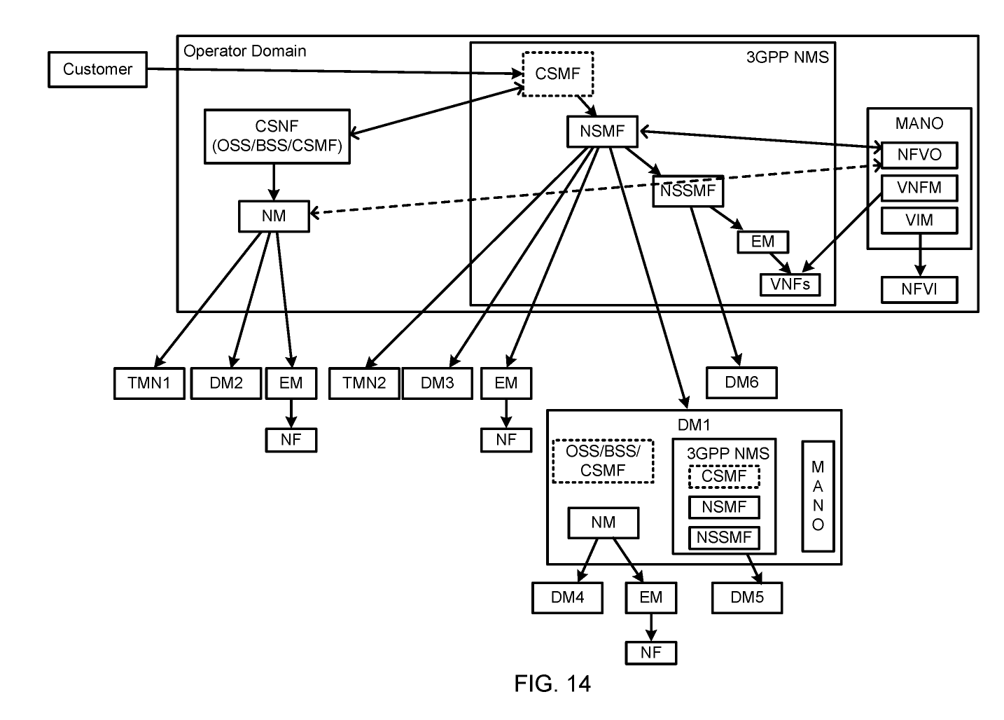

FIG. 14 is a block diagram schematically illustrating an example framework for interactions between the customer and network management functions, in a scenario in which the customer service negotiation function (CSNF) is in 3GPP domain. In the example of FIG. 14, the customer interacts primarily with a CSMF (which incorporates the functionality of the CSMF) in the 3GPP complaint Network Management System (NMS) for service negotiation. The CSMF of the 3GPP NMS may then interact with NSMF 408(s) and NSSMF 412(s) of the 3GPP NMS to reserve resources of one or more domains, slices and slice subnets subtending the 3GPP NMS for a negotiated SLA. The CSMF of the 3GPP NMS may also interact with a CSNF in the Operator Domain to reserve resources of one or more domains (such as DM2), Transport Networks (as represented by TNM 1) or network functions (NFs, for example via one or more element managers (EMs)) subtending the Operator Domain to support the negotiated SLA. If needed, the 3GPP NMS may also interact (for example via an NSMF 408 of the 3GPP NMS) with a MANO function for this same purpose. Similarly, the CSNF may also interact (for example via a NM) with a MANO function to support the negotiated SLA.

Different options for Network Operator Management System in providing different types of services. A function in 3GPP NMS or OSS/BSS called a Customer Service Negotiation Function (CSNF) may be defined to negotiate with the customer about the service requirements. The main service types provided by a 5G network are: (A) E2E Service Slice Instance (SSI) for a customer to serve the customers end user population service requirements; (B1) Network Slice Instance (NSI) to the customer to use it for its customers; (B2) Network Subnet-Slice Instance (NSSI) to the customer to be used for its communications services; and (C) VNF as a service, infra-structure as a service etc.

In some embodiments, it is assumed that the CSMF (Customer Service Management Function) provides the customer facing interface for all the service types. Alternatively, a CSNF may be defined in order to provide a common customer negotiation function for all services. This enables the CSMF to have a clear functional description that can be used to simplify the network design.

As may be appreciated, the present disclosure discusses the architectural and interfacing requirements for providing different types of slices to the customer. Accordingly, other functions that may be carried out by the CSNF is not discussed here. For example, the functionalities of a CSNF may include:
Customer service negotiation and SLA establishment
Customer service charging and billing
Customer service performance data sharing
The catalogue preparation for the offered service types and templates
Joint optimization of network resources, charging, competitive aspects and SLA parameters.

In some embodiments, CSNF functionalities may be identified as Customer Service Management (CSM), as distinct from Communication Service Management Function (CSMF). It may also be appreciated that in the case of conventional (or legacy) telecommunication networks, CSNF may also provide conventional OSS/BSS functionalities.

Embodiments utilizing the CSNF as the customer facing interface for all of the 5G service types offered by any of: a network operator; a network slice provider; a network sub-slice provider; or an infra-structure provider may exploit functionality of the CSNF that extends beyond traditional OSS/BSS functionality. The services provided by a traditional OSS/BSS primarily deal with the communications services to the end users. On the other hand, the CSNF provides services using network slices to Customers (who may be referred to as “Slice Customers”) with a large number of their own end users. The role of the CSNF may differ depending on the slice type. Therefore, in 5G systems there may be three options for CSNF functionality:
An integrated single entity (e.g. by enhancing conventional OSS/BSS) for customer service management of both 5G and traditional NM.
Keep traditional customer management (OSS/BSS) separate and introduce new CSNF functionality to handle sliced service customers. In this case, OSS/BSS may be used to provide the service to end users using conventional techniques. CSNF can also control the conventional network as a separate slice of its own controlled by traditional NM and may be used to even provide as a ‘sliced service’ to the OSS/BSS to serve the operator's own end users.
CSNF coordinates with the OSS/BSS to provide both the traditional end user services and the sliced 5G services.

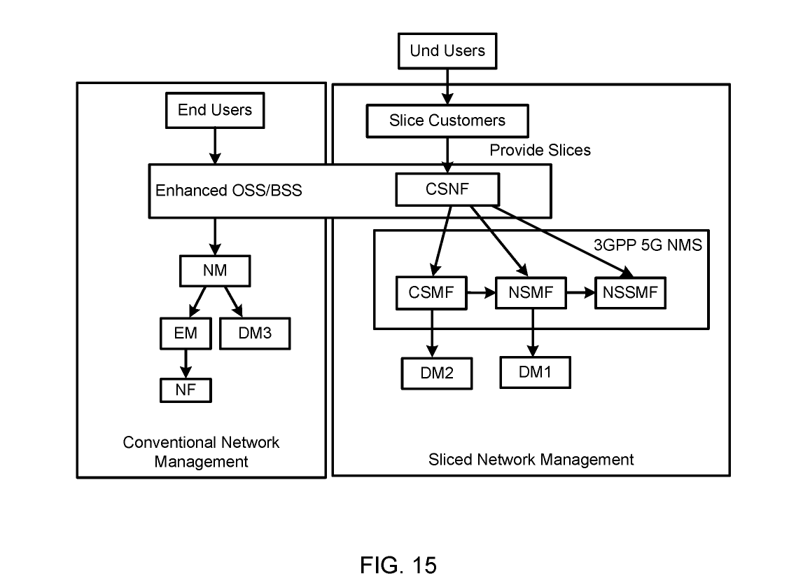

For each of these possible solutions, corresponding interfaces may be defined for different options. These three options are illustrated in FIGS. 15-17.

### Different Types of CSNF in Network Management System

FIG. 15 illustrates a framework utilizing an enhanced OSS/BSS deployed to act as the core of network management. To integrate new 3GPP slice-based NMS, the CSNF may be defined as a function of the enhanced OSS/BSS, and may be considered as a virtual network function.

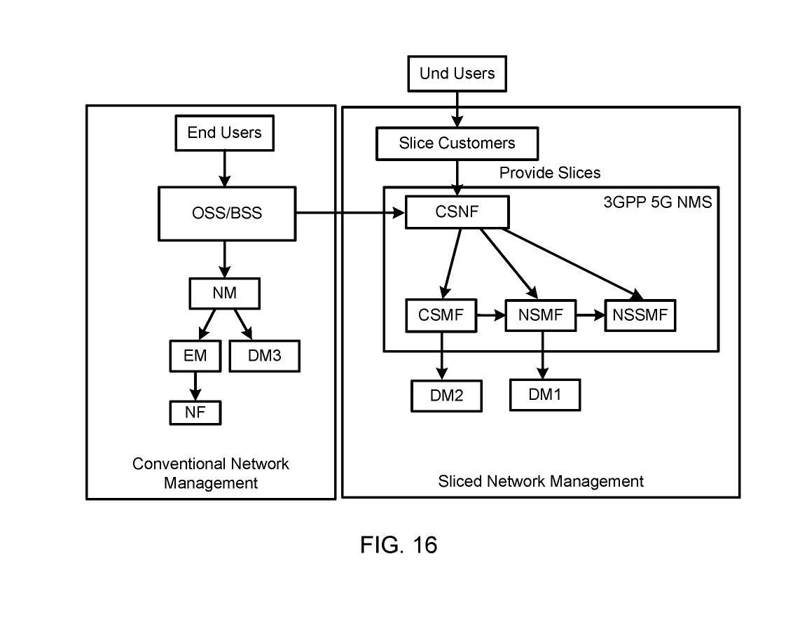

FIG. 16 illustrates a framework in which CSNF is incorporated into the 5G Network Management System separately from the conventional NM. As may be seen in FIG. 16, the conventional network management system and the CSNF (with new 3GPP NMs) are deployed separately. The OSS/BSS provides conventional communication services to end users and while the CSNF provides slices to slice customers. Interfaces between the CSNF, 3GPP NMS and OSS/BSS may be provided so that traditional networks can utilize new 3GPP network services.

New CSNF to manage services over both traditional NM and new 5G NMS.

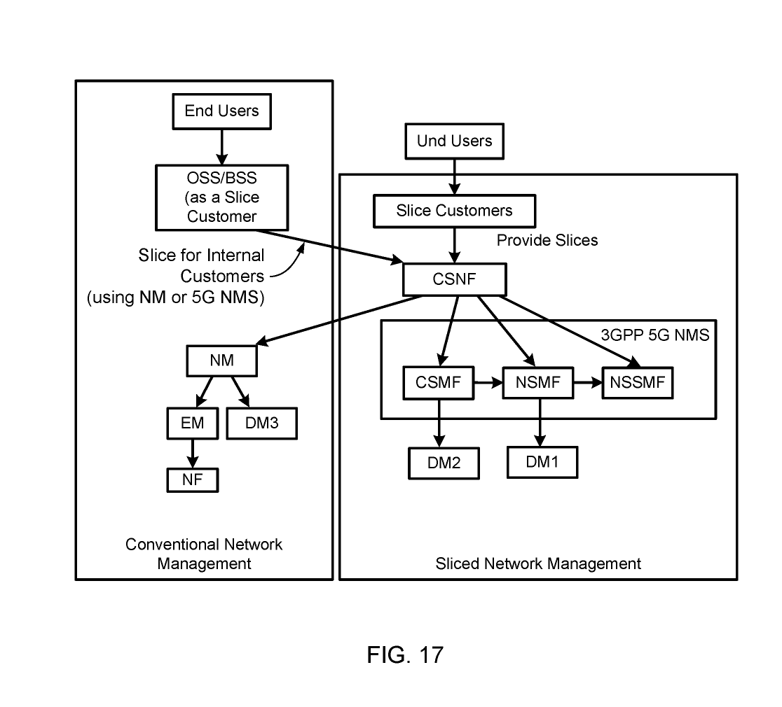

FIG. 17 illustrates a framework in which the CSNF is configured to manage services over both conventional NM and the 5G NMS. As may be seen in FIG. 17, in this embodiment, the CSNF is the core of the service management, which can be considered as a new OSS/BSS system. The conventional OSS/BSS is treated as a slice of the new service management system, so that the conventional network may be considered as a network slice of the integrated system. The conventional network management (NM) connects to the CSNF and, if needed, can be logically managed by OSS/BSS in a conventional way.

The new CSNF can be deployed either inside or outside the 3GPP system, as desired. In embodiments in which the CSNF is deployed outside the 3GPP system, interfaces between the CSNF and each of the NM, CSMF, NSMF, and NSSMF may be defined.

### Different Architecture Arrangement for Function Placement and 3GPP and Non-3GPP Control for Providing Different 5G Services

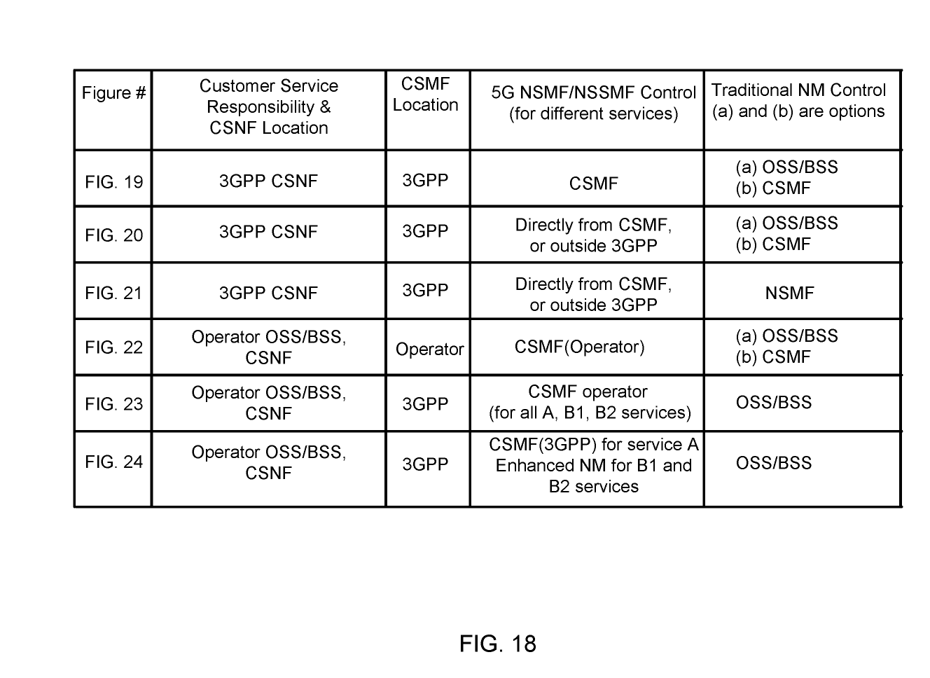

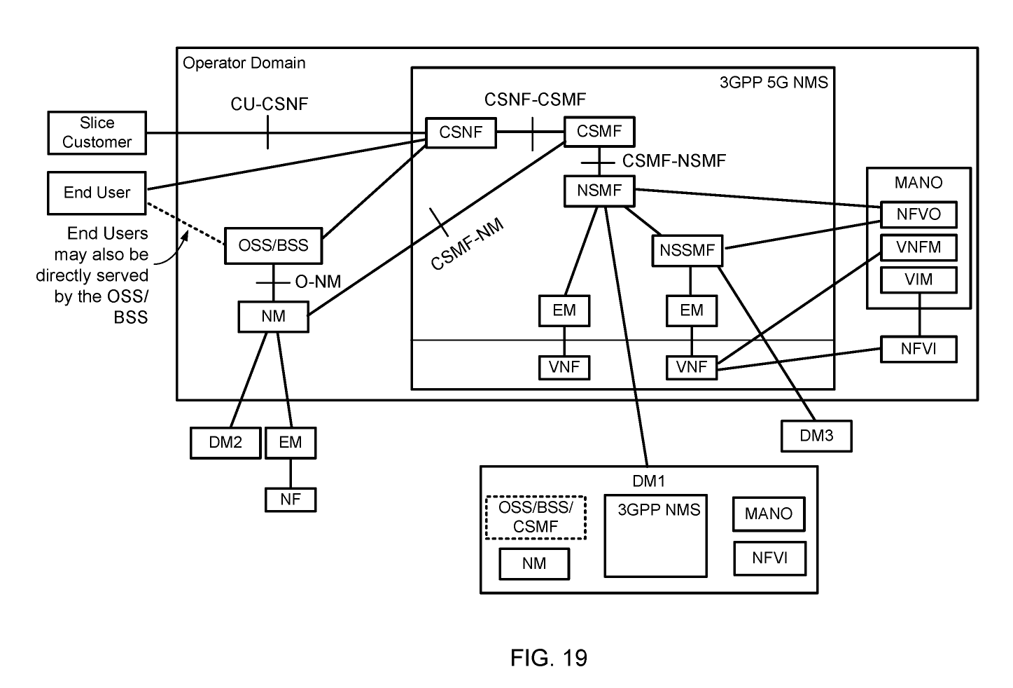

Considering the three options for SNF placement described above with reference to FIGS. 15-17, there were several ways the 3GPP management functions may interact with CSNF and OSS/BSS. Six possible scenarios are defined in the table shown in FIG. 18, and described in greater detail with reference to FIGS. 19-24.

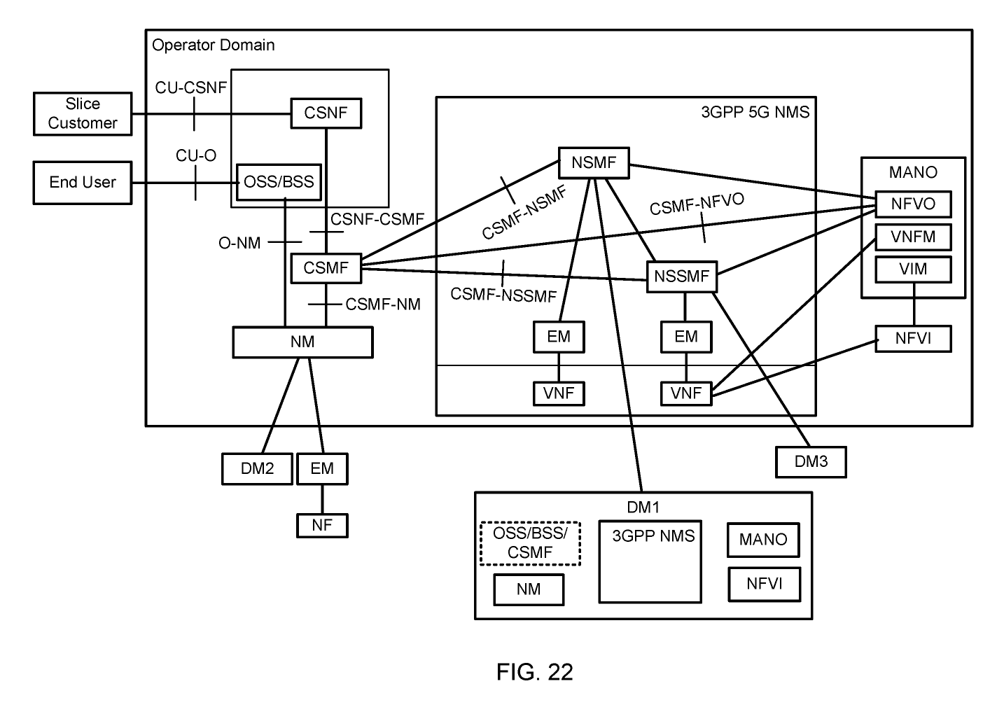

In the scenarios of FIGS. 19-21, the service provision responsibility is with the 3GPP 5G management system, whereas in the scenarios of FIGS. 22-24 the service provision responsibility is with the operator's non-3GPP management system. In all of these scenarios, the interactions between different functions need to be defined and these are described in the following subsections.

Service Provision Responsibility with 3GPP 5G NMS

This category is used for traditional NM, OSS/BSS incorporating the Slicing related new (5G) management system. In this category, CSNF and CSMF are both located in the 3GPP 5G NMS.

Scenario 1: CSNF goes through CSNF and CSMF for All Service Types

In this scenario, as shown in FIG. 19, the CSNF is located in the 3GPP 5G NMS, and acts as the only entity to face the customer. All services go through CSNF and CSMF, conventional services will be transferred to OSS/BSS and slice-based services will go to CSMF. CSMF, NSMF, NSSMF and etc. in 3GPP 5G NMS manage the network. Conventional NM can be managed by OSS/BSS or CSMF depended on different deployment types.

The new interfaces are:
(U1) CU-CSNF: For all 3 types of services. CU-OSS/BSS may be included in this interface (which is already defined).—defined in Section 3.
CSNF-OSS/BSS: This is just passing the conventional CU-OSS/BSS requirements.
(U2) CSNF-CSMF: Defined later in Section 3.
(U3) CSMF-NSMF: defined in Section 3.
CSMF-NM: This is similar to Oss/BSs-Nm interface. Csnf-Nsmf (obtaining a network slice instance) may also be expanded to have a common interface for these two cases since non-virtualized functions may need additional attributes. Since OSS/BSS-Nm is already defined in conventional networks this is not defined here.
(U4) NSMF-NSSMF: Defined in Section 3.
   CSNF Obtains Direct Services from NSMF and NSSMF for Type B1 and B2 Services

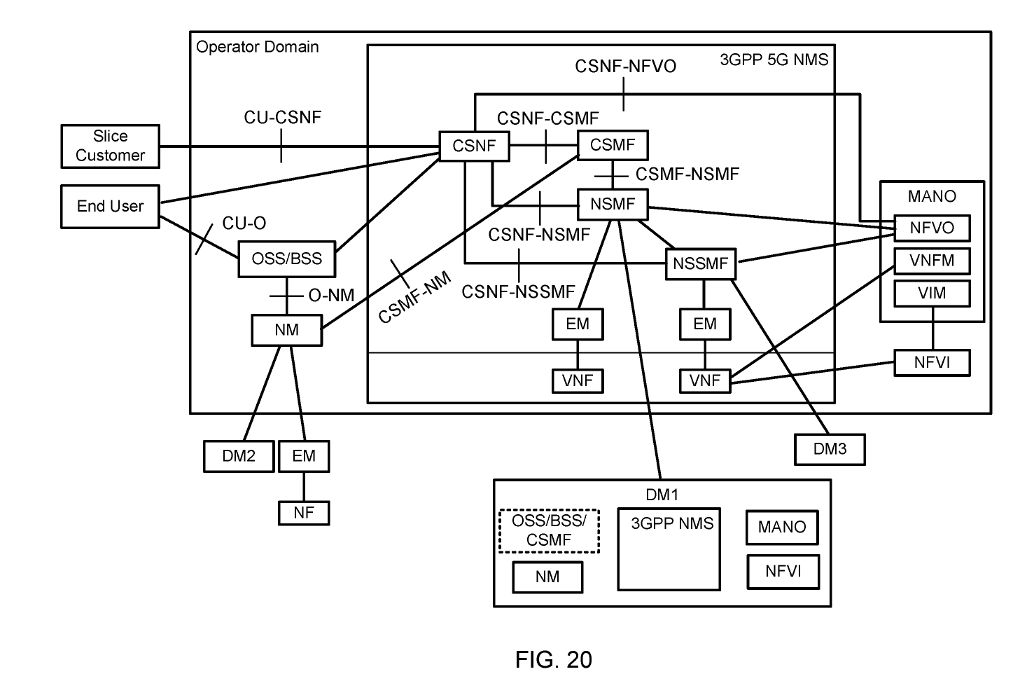

In this case, as shown in FIG. 20, CSNF is in 3GPP 5G NMS and act as the only part facing the customer. CSMF only manage E2E service. CSNF directly handles other services with NSMF/NSSMF/VNF. Conventional NM can be managed by OSS/BSS or CNMF depending on different deployment types.

In this case, the interfaces (in addition to those described above with reference to FIG. 19) required are:
(U5) CSNF-CSMF: This is now only for service type A. So this is a subset of previous interface attributes. Defined in Section 3.
CSNF-NM: This is similar to previous CSMF-NM definition.
CSNF-NSMF: This is similar to CSMF-NSMF—(U3)
CSNF-NSSMF: This is similar to NSMF-NSSMF (U4)
   Different Services Managed by Different MFS with NSMF Managing Conventional Network Management

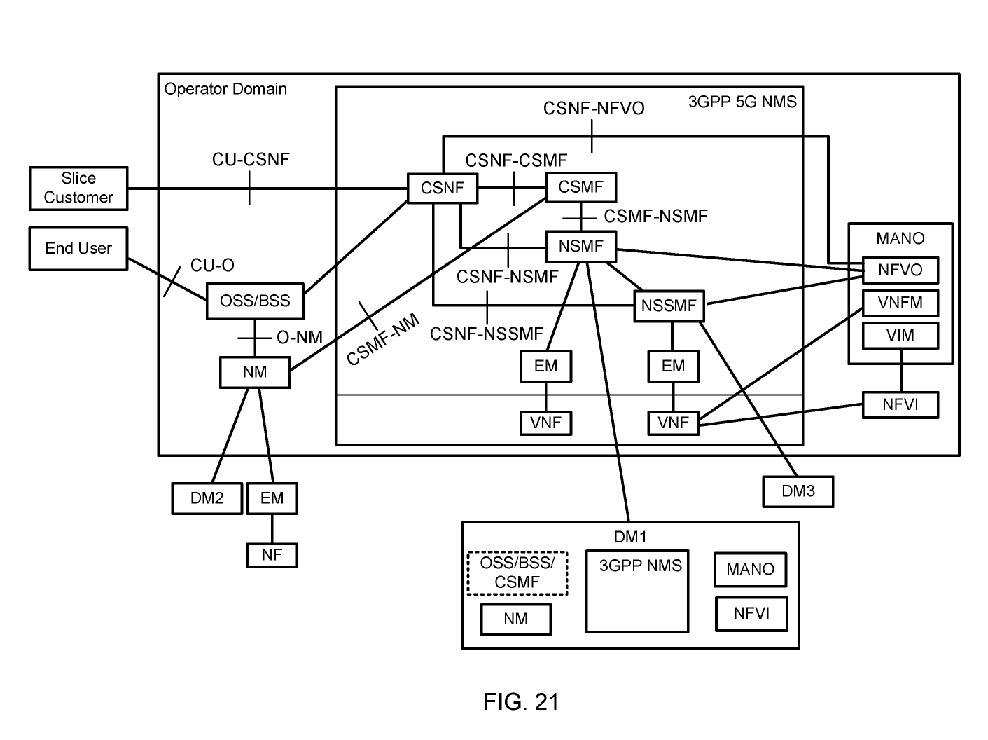

In this case, as shown in FIG. 21, the CSNF is located in the 3GPP 5G NMS and act as the only part facing the customer. The CSMF only manages E2E services. NSMF 408 does overall network Management. Conventional NM can be managed by OSS/BSS or NSMF 408 depended on different deployment types.

New interface requirements (in addition to those described above with reference to FIGS. 19 and 20) are:
(U6) NSMF-NM: This might have different components than O-Nm—defined in Section 3.

### CSNF and CSMF in Operator Domain (NM)

In this case, as shown in FIG. 22, the CSNF is located in the Operator Domain. In some embodiments, the CSNF may be integrated with OSS/BSS as described above, or it may act as a separate entity. The CSMF is also located in the operator domain and manages the NSMF 408 and NSSMF 412 in the 3GPP 5G NMS. Conventional NM can be managed by OSS/BSS or CSMF depended on different deployment types.

In this case, whole network management is controlled by NM+CSMF operator functions. This combination can be considered as an Enhanced NM to do slice design.

All of the interfaces required for this scenario have been described above with reference to FIGS. 19-21.

### NM In-Charge of the Overall Network Design

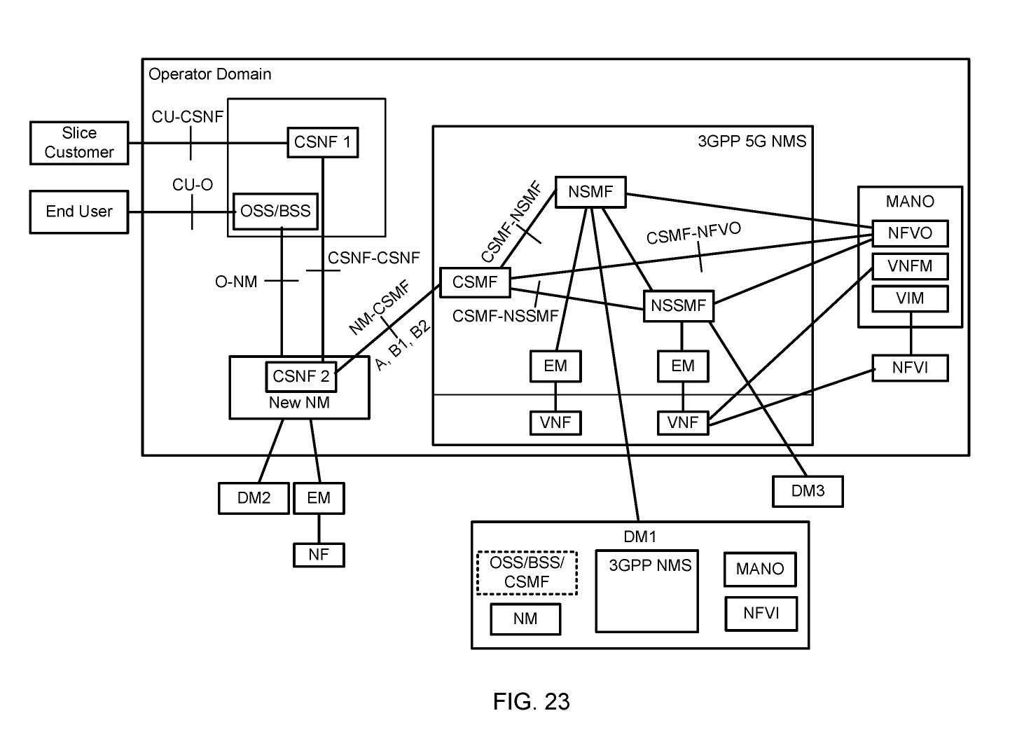

In this case, as shown in FIG. 23, the CSNF is located in the Operator Domain. The CSNF may be integrated with OSS/BSS or act as a separate entity. The NM in the Operator Domain may be considered to be a new enhanced NM, which means it incorporates CSNF and so can take responsibility for managing CSMF, NSMF 408, NSSMF 412 and VNF in the 3GPP 5G domain. The overall network design is done by this enhanced NM. CSMF only creates E2E service and other services and provides them to this enhanced NM. Conventional NM can be managed by OSS/BSS.

New interface requirements (in addition to those described above with reference to FIGS. 16-19) are:
Enhanced NM to CSMF: This is similar to the CSNF-CSMF interface described at (U2) above.
If enhanced OSS/BSS is provided as a single unit, the CU-CSNF interface (defined at (U1) above) needs to be added to the current CU-O interface.

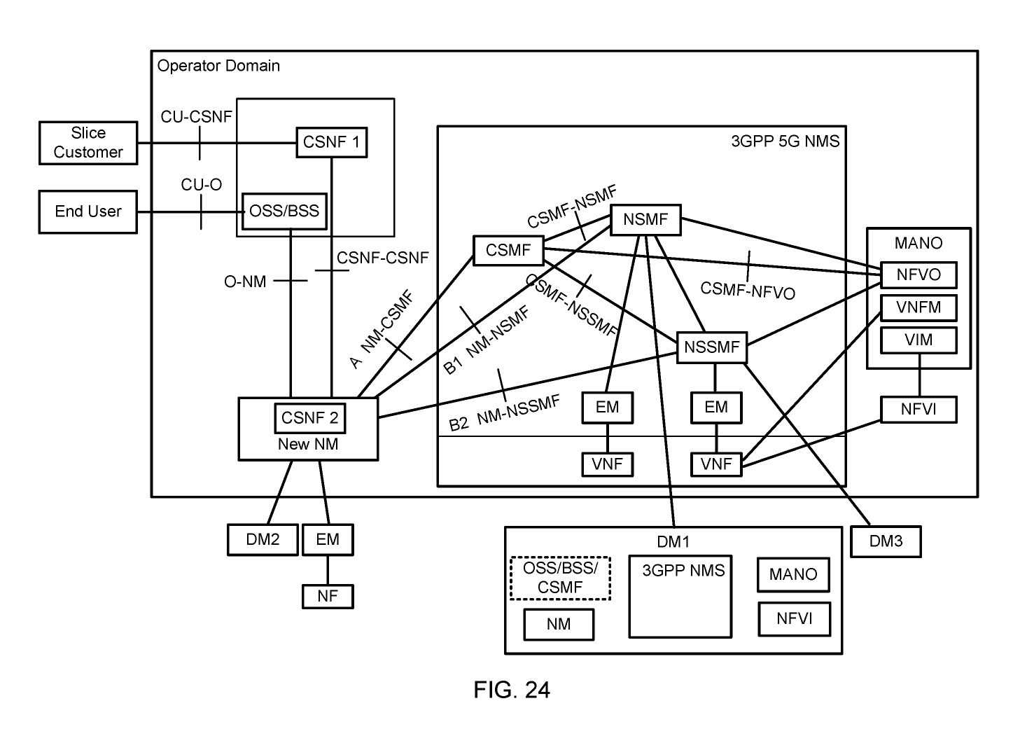

As may be seen in FIG. 23, the CSMF in the 3GPP 5G domain handles interaction between the CSNF (or enhanced NM) and each of the CSMF, NSMF 408, NSSMF 412 and VNF in the 3GPP 5G domain for service types A, B1 and B2. FIG. 24 illustrates a variation of this embodiment, in which separate interfaces are provided between the CSNF and each of the CSMF, NSMF 408 and NSSMF 412. In this case, the NSMF 408 and NSSMF 412 also handle interactions between the CSNF (or enhanced NM) and the VNF.

The following description provides a definition of each of the principle new network management functions

CSNF (Customer Slice Negotiation Function) negotiates the service requirements with the customer. CSNF also verifies the resource availability for the 3 service types from different entities, CSMF, NSMF 408 or NSSMF 412, NM etc for admission control. After admission control it uses all the service offering possibilities with the cost aspects and negotiate a service with the customer. Once agreed an SLA is established.

SLA requirements are then passed to CSMF or whoever handles the particular type of service. If it is type A it is passed to CSMF (similarly type B1 to NSMF 408 and B2 NSSMF 412 in the case those services are not done through CSMF).

CSMF (Customer Slice Management Function) is the service layer of the management plane. This handles service requirements as per the SLA and converts them into network slice requirements and pass them to NSMF 408 or NSSMF 412 as appropriate. This also keep a service slice descriptor and service performance etc. databases. It also decides whether multiple services need to be served by a single NSSI after clarifying with the NSMF 408 if allowed by the SLA.

NSMF 408 (Network Slice Management Function) facilitates the network slice instantiation, incorporation of the services, etc. according to the network requirements provided by the CSMF. It also provides information of the resource availability in the admission control phase.

NSSMF 412 (Network Sub-Slice Management Function) facilitates the network subslice instantiation, incorporation of the services, etc. It also provides information of the resource availability in the admission control phase.

### (U1) CU-CSNF: Interface Between Customer and CSNF

This interface can be used for requesting, negotiation, and feedback of service including E2E slice service, NSI (NSSI) as-a-service, VNF as-a-service, as shown in FIGS. 1, 2, 3 and 7.

Through this interface, requests, attributes (with requirements) of the service can be transmitted to CSNF and CSNF can negotiate with customers. Attributes of the service can be:
Service Type: E2E slice service, NSI (NSSI) as-a-service, VNF as-a-service
Service related requirements
Charging requirements
Exposure requirements
etc.

### (U2) CSNF (NM)—CSMF: Interface Between CSNF/NM and CSMF

This interface is used for CSMF to receive requests and requirements of services as well as provide management information of services. Through this interface, requests and attributes (with requirements) of the service, management information and etc. can be transmitted between CSNF (NM) and CSMF.
CSNF-CSMF is used in cases in FIGS. 19-21.
NM-CSMF is used in cases in FIGS. 23-24.

Attributes of the service can be:
Service Type: E2E slice service, NSI (NSSI) as-a-service, VNF as-a-service
Service related requirements
Charging requirements
Exposure requirements

### (U3) CSNF (CSMF,NM)-NSMF: Interface Between CSNF (CSMF, NM) And NSMF 408

This interface is used for NSMF 408 to receive requests and requirements of services as well as provide management information of services, as shown in FIGS. 1-3 and 7-9

Through this interface, requests and attributes (with requirements) of the services (e.g., NSI, NSSI, VNF), management information and etc. can be transmitted between CSNF (CSMF, NM) and NSMF 408. This interface can be used for NSI (NSSI) as-a-service, VNF as-a-service FIGS. 20 and 21.
CSNF-NSMF 408 is used in cases in FIGS. 21 and 22.
CSMF-NSMF 408 is used in cases in FIGS. 19, 22 and 23.
NM-NSMF 408 is used in cases in FIG. 24.

Following attributes of the service can be transmitted to NSMF 408:
Service Type: NSI, NSSI, and VNF
Service related requirements
Charging requirements
Exposure requirements
Etc.

### (U4) CSNF (CSMF,NM,NSMF)-NSSMF: Interface Between CSNF (CSMF, NM, NSMF 408) and NSSMF 412

Same as (U3) CSNF-NSMF 408 except different attributes, only for NSSI and VNF.

### (U5) CSNF-CSMF

This interface is used for CSMF to receive requests and requirements of services as well as provide management information of services only for E2E slicing. Through this interface, shown in FIGS. 19-24, requests and attributes (with requirements) of the service, management information and etc. can be transmitted between CSNF and CSMF.

Attributes of the service can be:
1. Service related requirements
2. Charging requirements
3. Exposure requirements
4. etc.

### (U6) NSMF (CSNF, CSMF)-NM

This interface is used for 3GPP 5G NMS and Operator to management (coordinate with) traditional networks as shown in FIGS. 20-21. In this case, this is similar to O-NM. Differences are:
Exposure level may be different;
Service requirements may be different;
NSMF 408-NM is used in the case in FIG. 21.
CSMF-NM is used in the case in FIGS. 19 and 22
CSNF-NM is used in the case in FIG. 20.

Based on the foregoing, it may be appreciated that embodiments of the present invention may provide any one or more of:
A system for managing a network comprising at least one network slice instance (NSI) including at least one network slice subnet instance (NSSI), the system comprising: a network slice management function (NSMF 408) associated with each NSI, the NSMF 408 configured to manage its associated NSI; and a network slice subnet management function (NSSMF 412) associated with each NSSI, the NSSMF 412 configured to manage its associated NSSI.
   In some embodiments, the NSSMF 412 is configured to share resources of its associated NSSI with either one of the NSI and another NSSI.
   In some embodiments, the NSSMF 412 is configured to expose either one or both of Radio Access Network (RAN) capabilities and Core Network Function capabilities.
   In some embodiments, the NSSMF 412 is configured to provide either one or both of User plane connectivity and control-plane connectivity.
   In some embodiments, the NSSMF 412 is configured by a claiming NSSMF 412 to selectively manage reserved resources itself or provide access to management procedures to the claiming NSSMF 412.
   In some embodiments, the NSSMF 412 is instantiated in a first provider domain, and the claiming NSSMF 412 is instantiated in a second provider domain.
   In some embodiments, the NSSMF 412 is configured to respond to a request from a second NSSMF 412 to use resources by: verifying that the request complies with one or more defined policies; when the request complies with one or more defined policies, reserving resources in accordance with the request, and providing information to the second NSSMF 412 for using and accessing the reserved resources.
   In some embodiments, the NSSMF 412 is configured to forward monitoring information pertaining to the reserved resources to the second NSSMF 412.
A system for managing a network comprising an Operator Domain, the system comprising: a Communications Service Negotiation Function configured to interact with a customer to negotiate a network service level agreement; and interact with one or more management functions of the Operator Domain to reserve network resources for the negotiated service level agreement.
   In some embodiments, the one or more management functions of the Operator

Domain comprise any one or more of: a network manager of the Operator Domain; another Communications Service Management Function instantiated in a 3GPP compliant Network Management System of the Operator Domain; a Network Slice Management Function; and A Network Slice Subnet Management Function.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by modules or functional elements specific to those steps. The respective units/modules may be implemented as specialized hardware, software executed on a hardware platform that is comprised of general purpose hardware, or a combination thereof. For instance, one or more of the units/modules may be implemented as an integrated circuit, such as field programmable gate arrays (FPGAs) or application-specific integrated circuits (ASICs). It will be appreciated that where the modules are software, they may be stored in a memory and retrieved by a processor, in whole or part as needed, individually or together for processing, in single or multiple instances as required. The modules themselves may include instructions for further deployment and instantiation.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A system for managing a network, the system comprising:
a network slice subnet management function (NSSMF) associated with a network slice subnet instance (NSSI) including a first allocation of network function resources and network function management resources of the network, the network slice subnet management function configured to manage operation of the NSSI; and
a network slice management function (NSMF) associated with a network slice instance (NSI) that includes the NSSI and a second allocation of network function resources and network function management resources of the network, the network slice management function configured to: manage operation of the second allocation of network function resources and network function management resources, and interact with the NSSMF to manage operation of the NSSI.

2. The system as claimed in claim 1, wherein the NSSMF is further configured to share resources of its associated NSSI with either one or both of the NSI and a second NSSI.

3. The system as claimed in claim 1 wherein the first allocation of network function resources and network function management resources comprise either one or both of Radio Access Network (RAN) functions and Core Network (CN) functions.

4. The system as claimed in claim 3 wherein the Radio Access Network (RAN) functions and Core Network (CN) functions comprise either one or both of User plane connectivity and control-plane connectivity.

5. The system as claimed in claim 2 where the NSSMF is responsive to a first request from a parent management function to selectively manage the first allocation of network function resources, the parent management function being either one or both of the NSMF associated with the NSI and a second NSSMF associated with the second NSSI.

6. The system as claimed in claim 5 where the first message comprises a request to expose any one or more of:
an identification of available network function types, an identification of available network function pools;
a maximum authorized range to request extension of available network function pools; and
an available capacity of each available network function type.

7. The system as claimed in claim 6 where the identification of available network function types comprises identification of any one or more of:
network functions associated with physical network resources;
virtualized network functions; and
a respective location of each network function.

8. The system as claimed in claim 6 where the available capacity of each available network function type comprises any one or more of:
a maximum number of simultaneous sessions;
an identification of available sessions types;
an identification of maximum available throughput;
an identification of an available latency budget;
an identification of radio access network (RAN) capabilities; and
an identification of core network (CN) capabilities

9. The system as claimed in claim 8 wherein the identification of radio access network (RAN) capabilities comprises, for a particular RAN node, an identification of any one or more of:
a coverage area;
a maximum simultaneous UE connectivity;
a maximum total throughout;
a slicing capability;
an interference map;
a beamforming capability; and
classes of UE supported.

10. The system as claimed in claim 8 wherein the identification of core network (CN) capabilities comprises, for a particular core network function, an identification of any one or more of:
a Number of active sessions;
a NF loading; and
a link loading

11. The system as claimed in claim 5 wherein the NSSMF is responsive to a second request from the parent management function to expose, to the parent management function, at least a portion of the first allocation of network function management resources, such that the parent management function can manage operation of the first allocation of network function resources in accordance with the exposed portion of the first allocation of network function management resources.

12. The system as claimed in claim 11 wherein the second request comprises a request to expose any one or more of:
capabilities of logical links that can be established between network functions;
expected cost of activating or using a particular network function;
required latency between network function types;
consumed capacity between network functions;
alarm tracking facilities;
security facilities;
performance monitoring facilities; and
data caching facilities.

13. The system as claimed in claim 5 wherein the NSSMF is instantiated in a first provider domain, and the parent management function is instantiated in a second provider domain different than the first provider domain.

14. The system as claimed in claim 2 wherein the NSSMF is configured to respond to a share request from a second management function to share resources by:
verifying that the share request complies with one or more predetermined policies;
when the request complies with one or more predetermined policies, reserving resources in accordance with the share request, and providing information to the second management function for using and accessing the reserved resources.

15. The system as claimed in claim 14 wherein the NSSMF is configured to forward monitoring information pertaining to the reserved resources to the second management function.

16. The system as claimed in claim 1, wherein the NSMF is further configured to share resources of its associated NSI with either one or both of a communication service instance and a second NSI.

17. The system as claimed in claim 1 wherein the second allocation of network function resources and network function management resources comprise either one or both of Radio Access Network (RAN) functions and Core Network (CN) functions.

18. The system as claimed in claim 17 wherein the Radio Access Network (RAN) functions and Core Network (CN) functions comprise either one or both of User plane connectivity and control-plane connectivity.

19. The system as claimed in claim 16 where the NSMF is responsive to a first request from a parent management function to selectively manage the first allocation of network function resources, the parent management function being either one or both of a communication service management function (CSMF) associated with the communication service instance and a second NSMF associated with the second NSI.

20. The system as claimed in claim 19 where the first message comprises a request to expose any one or more of:
an identification of available network function types,
an identification of available network function pools;
a maximum authorized range to request extension of available network function pools; and
an available capacity of each available network function type.

21. The system as claimed in claim 20 where the identification of available network function types comprises identification of any one or more of:
network functions associated with physical network resources;
virtualized network functions; and
a respective location of each network function;

22. The system as claimed in claim 20 where the available capacity of each available network function type comprises any one or more of:
a maximum number of simultaneous sessions;
an identification of available sessions types;
an identification of maximum available throughput;
an identification of an available latency budget.
an identification of radio access network (RAN) capabilities; and
an identification of core network (CN) capabilities

23. The system as claimed in claim 22 wherein the identification of radio access network (RAN) capabilities comprises, for a particular RAN node, an identification of any one or more of:
a coverage area;
a maximum simultaneous UE connectivity;
a maximum total throughout;
a slicing capability;
an interference map;
a beamforming capability; and
classes of UE supported.

24. The system as claimed in claim 22 wherein the identification of core network (CN) capabilities comprises, for a particular core network function, an identification of any one or more of:
a Number of active sessions;
a NF loading; and
a link loading

25. The system as claimed in claim 19 where the NSMF is responsive to a second request from the parent management function to expose, to the parent management function, at least a portion of the second allocation of network function management resources, such that the parent management function can manage operation of the second allocation of network function resources in accordance with the exposed portion of the second allocation of network function management resources.

26. The system as claimed in claim 25 wherein the second request comprises a request to expose any one or more of:
capabilities of logical links that can be established between network functions;
expected cost of activating or using a particular network function;
required latency between network function types;
consumed capacity between network functions;
alarm tracking facilities;
security facilities;
performance monitoring facilities; and
data caching facilities.

27. The system as claimed in claim 19 wherein the NSMF is instantiated in a first provider domain, and the parent management function is instantiated in a second provider domain different than the first provider domain.

28. The system as claimed in claim 27 wherein the NSMF is configured to respond to a share request from a second management function to share resources by:
verifying that the share request complies with one or more predetermined policies;
when the request complies with one or more predetermined policies, reserving resources in accordance with the share request, and providing information to the second management function for using and accessing the reserved resources.

29. The system as claimed in claim 28 wherein the NSMF is configured to forward monitoring information pertaining to the reserved resources to the second management function.
